(19) United States
(12) Patent Application Publication
(10) Pub. No.: US 2006/0218071 A1
(43) Pub. Date: Sep. 28, 2006

(54) System and method for managing trading between related entities

(75) Inventor: Michael Sweeting, Aldershot (GB)

Correspondence Address: BAKER BOTTS L.L.P., 2001 ROSS AVENUE, SUITE 600, DALLAS, TX, 75201-2980, US

(73) Assignee: eSpeed, Inc., New York, NY (US)

(21) Appl. No.: 11/091,137

(22) Filed: Mar. 28, 2005

(51) Int. Cl. G06Q 40/00

(52) U.S. Cl. 705/37

(57) ABSTRACT

A method for managing electronic trading is provided. In an electronic market having trade matching rules, a plurality of first orders each associated with an account are received. A contra order is also received at the electronic market. For each of one or more first orders, it is electronically determined whether that order is a related first order by determining whether the account associated with that order has a particular relationship with the particular account associated with the contra order. Without intentionally introduced delay, one or more particular first orders, including one or more related first orders, are electronically determined to trade with the contra order based at least on the trade matching rules and the determination of related first orders. One or more trades between the one or more particular first orders and the contra order are automatically executed.

### TECHNICAL FIELD OF THE INVENTION

This invention relates in general to market trading and, more particularly, to a system and method for managing trading between related entities in an electronic market.

### BACKGROUND OF THE INVENTION

The cornerstone of economic activity is the production and consumption of goods and services in a market economy. Economic efficiency and market performance are measured by the distribution of such goods and services between a buyer and a seller. The value of goods and services is usually expressed in a currency of denomination, such as United States dollars. Such economic activity extends beyond national borders. The trading of goods and services occurs across international borders, creating a market in which currency itself is traded and is governed by the laws of supply and demand.

Throughout history, many different approaches have been adopted to bring buyers and sellers of goods, services, and currency together, each with the key objective of permitting transactions at or as close as possible, to the “market” price of the tradable item. The market price is the price (in given currency terms) that a fully educated market will transact selected products. In order to achieve this, all potential buyers and sellers should have full and equal access to the transaction. The buyer and seller transaction must be structured to operate at very low costs or it will distort the market price of the tradable items with artificially high transaction costs. The keys to effective buyer and seller transactions are full and timely access of expression and knowledge, and low transaction costs. However, there are often conflicting yet necessitating trade-offs between trading efficiency and market knowledge.

In recent years, electronic trading systems have gained a widespread acceptance for trading items, such as goods, services, and currency. For example, electronic trading systems have been created which facilitate the trading of financial instruments such as stocks, bonds, currency, futures, or other suitable financial instruments. In particular, electronic trading systems have become popular for the trading of securities, particularly for the trading of fixed-income securities, such as United States Treasuries, United Kingdom Gilts, European Government Bonds, and Emerging Market debts, and non-fixed income securities, such as stocks.

Many of these electronic trading systems use a bid/offer process in which traders submit buy (or bid) and sell (or offer) orders for a particular tradable instrument. The buy and sell orders are received by a trading exchange and placed onto a trading exchange for the particular tradable instrument. Received buy orders may be placed in a buy order queue, or stack, and received sell orders may be placed in a sell order queue, or stack. Received orders may be placed into such stacks in various different manners, such as matching buy and sell orders using a FIFO (first in, first out) matching system, matching according to a price/time priority auction protocol matching system as detailed in U.S. Pat. No. 6,560,580, or otherwise based on the bid and offer prices associated with each of the received buy and sell orders, for example.

### SUMMARY OF THE INVENTION

In accordance with the present invention, system and methods are provided for managing trading between related entities in an electronic market, such that trading may be technically managed within a trading system to avoid unnecessary messaging and transaction charges; and optimizing executions for trades between related entities.

According to one embodiment, a method for managing electronic trading is provided. In an electronic market having trade matching rules, a plurality of first orders each associated with an account are received. A contra order is also received at the electronic market. For each of one or more first orders, it is electronically determined whether that order is a related first order by determining whether the account associated with that order has a particular relationship with the particular account associated with the contra order. Without intentionally introduced delay, one or more particular first orders, including one or more related first orders, may then be electronically determined to trade with the contra order based at least on the trade matching rules and the determination of related first orders. One or more trades between the one or more particular first orders and the contra order may then be automatically executed.

According to another embodiment, a method for managing electronic trading is provided. A plurality of orders including buy orders and sell orders are received at in an electronic market, each received order having a price. It is electronically determined that the price of a first one of the plurality of orders matches or crosses the price of a second one of the plurality of orders and a third one of the plurality of orders, the first order being received from a first trading entity, the second order being received from a second trading entity, and the third order being received from a third trading entity. It is then electronically determined whether the second trading entity has a particular relationship with the first trading entity. If the second trading entity has the particular relationship with the first trading entity, a trade is automatically initiated without intentionally introduced delay between the first order and the second order. However, if the second trading entity does not have the particular relationship with the first trading entity, a trade is automatically initiated without intentionally introduced delay between the first order and the third order.

According to yet another embodiment, another method for managing electronic trading is provided. A first order is received at an electronic market from a first account. During an auction for trading with the first order, auction entries are received from a second account and a third account. It is electronically determined that the first final auction entry is related to the first order and that the second final auction entry is not related to the first order. Based at least on the determination that first final auction entry is related to the first order, the first final auction entry is determined to be executed first, and a trade is executed between the first order and the winning first auction entry.

According to yet another embodiment, another method for managing electronic trading in an electronic market is provided. An electronic order routing system operable to route trading orders to multiple electronic markets electronically receives a plurality of trading orders, each trading order associated with a trading account and having a price. The electronic order routing system electronically routes each of the received trading orders to one of the multiple electronic markets in accordance with one or more routing algorithms defined within it. The electronic order routing system electronically receives a contra trading order associated with a trading account. The electronic order routing system then electronically determines, for one or more of the routed trading orders, whether that previously routed trading order is related to the contra trading order by determining whether the trading account associated with that previously routed trading order has a relationship with the particular trading account associated with the contra trading order. If at least one or more of the subset of routed trading orders are determined to be related to the contra trading order, the electronic order routing system communicates a message to the electronic market to which a particular related trading order was routed to cancel at least a portion of the particular related trading order. The electronic order routing system, on receipt of an acknowledgement of a successful cancellation of a portion (or all) of the previously routed trading order, may then cause a trade to be executed between the contra trading order and the cancelled portion (or all) of the related trading order. If no routed order having an appropriate price is determined to be related to the contra order, the electronic order routing system may route the contra order to one of the multiple electronic markets.

Various embodiments of the present invention may benefit from numerous advantages. It should be noted that one or more embodiments may benefit from some, none, or all of the advantages discussed below.

One advantage of the invention is that in some embodiments, an electronic trading and order routing system is provided in which “related” trading orders—for example, trading orders received from trading accounts having one of a variety of relationships—may be automatically “in-house matched” with each other before being matched with non-related trading orders at the same price. In some embodiments, the exchange matches (or attempts to match) related trading orders without breaking the existing, or regular, trading rules or logic of the exchange. Thus, related trading orders may be “in-house matched” with each other without breaking the existing, or regular, trading rules or logic of the exchange, or without breaking exchange or other governmental regulations. Such regular trading rules or logic may include, for example, regular price/time priority matching rules, pro rata matching rules, or auction matching rules. In addition, by submitting the trading orders to the trading exchange for matching, full price discovery of the exchange is still provided such that the fair market price of the exchange is realized for each trade.

Thus, traders who have placed trading orders which are then matched with new related trading orders by the in-house matching techniques discussed herein may have their orders filled faster than they would otherwise be filled. In addition, in some situations, if trading orders from the same or related entities are in-house matched on the exchange, the trade may be handled internally on the books of that entity, thus saving fees that would otherwise be assessed to the entity by the exchange.

Another advantage will become apparent to those having ordinary skill in the art wherein high volume trading companies can technically limit the bandwidth they use for trading. Many companies facilitate multiple users trading from their own individual accounts using services provided by that trading company. Such trading companies often use single points of access to trading systems, which can become rapidly congested at times of high volatility with orders from their multiple users. Where a trading company uses an electronic order routing system as described herein, they can avoid excess bandwidth usage alongside executing their users' orders in preference to other unrelated users on the trading systems to which they are connected, often with more timely results if the trading system itself is subject to a high message load at these times.

A common constraint on electronic exchanges is a high volatility of the market both in terms of prices and of changes in available quantities of an instrument or commodity traded. This constraint may have the technical consequence that data may be provided to an exchange at a rate and a degree of complexity that challenges the system designer. Exchanges in general and trading interfaces in particular may help or hinder a trader in his aim of making a profit. It is desirable to provide trading exchanges functionality for communicating internally in a data-efficient way to provide traders the best chance to follow a market situation and to react to it quickly and accurately.

One problem arising in particular trading environments is that the time to make a full entry of an order onto the system may be greater than the time for the relevant market conditions to change. Thus, at the time an entry is initiated a trader may be intending to make a counter order to a existing entry already displayed, but by the time that entry is complete the existing entry may no longer be available, having been traded by somebody else or otherwise removed from the market. In such instances of high volatility, users cannot afford the time to seek out contra traders within their own same firm, company or legal entity, for example, who may be participating in the market for the same instrument. The invention disclosed herein allows substantially reduces or eliminates this problem by identifying and executing such “in house” trade matches first within the matching rules of the relevant marketplace.

Other advantages will be readily apparent to one having ordinary skill in the art from the following figures, descriptions, and claims.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example trading system for managing trading, including in-house matching of related trading orders, in an electronic market;

FIG. 2 illustrates an example configuration of the trading system of FIG. 1, including a number of trading workstations coupled to a trading exchange via a communications network;

FIG. 3 illustrates a method showing the general cooperation between regular trading rules and in-house matching rules of a trading exchange in matching related and/or non-related trading orders in accordance with some embodiments of the invention;

FIG. 4 illustrates an example method of applying in-house matching rules to regular price/time trading rules in accordance with one embodiment of the invention;

FIG. 5 illustrates an example method of applying in-house matching rules to “trading through the stack” trading rules in accordance with one embodiment of the invention;

FIG. 6 illustrates an example method of applying in-house matching rules to “mini-auction” regular trading rules in accordance with one embodiment of the invention;

FIG. 7 illustrates an example trading system including an electronic order routing system operable to route trading orders to multiple electronic trading exchanges and manage trading, including in-house matching of related trading orders, among the multiple electronic trading exchanges in accordance with one embodiment of the invention; and

FIG. 8 illustrates an example method of the trading system of FIG. 7 managing the matching and trading of trading orders in a particular embodiment of the invention.

### DETAILED DESCRIPTION OF THE DRAWINGS

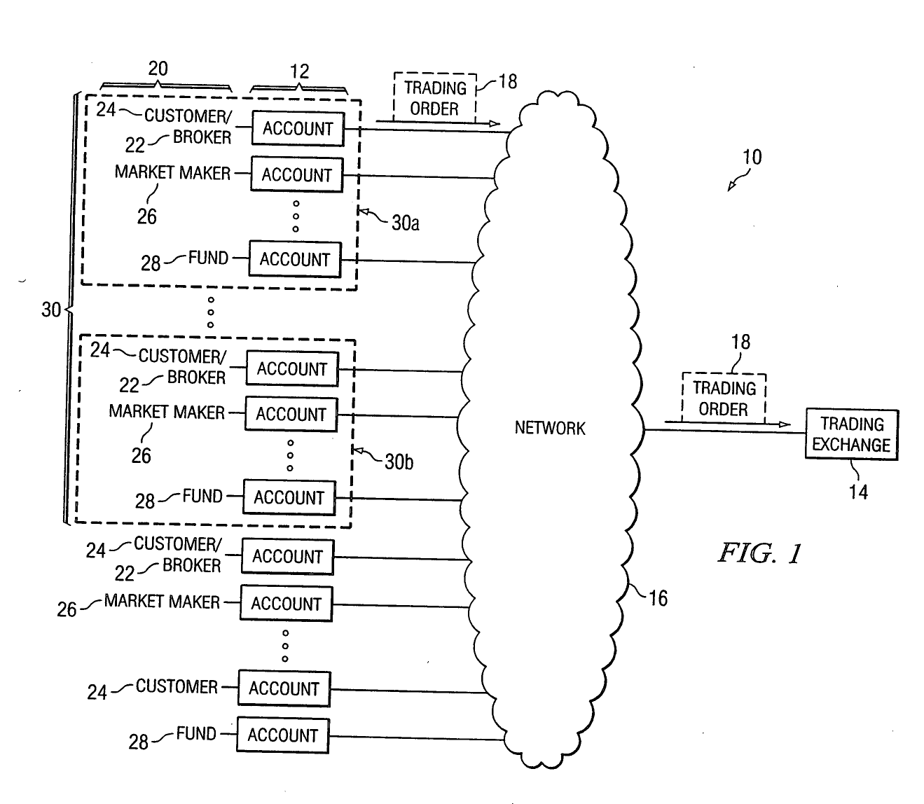

Example embodiments of the present invention and their advantages are best understood by referring now to FIGS. 1 through 8 of the drawings, in which like numerals refer to like parts. In general, according to at least some embodiments, electronic trading systems and methods are provided that facilitate the matching and execution of trades between trading orders associated with related trading accounts, such as trading orders received from trading accounts associated with the same company, different companies within the same entity, legally related entities, entities associated with the same holding company, or trading accounts otherwise having some predetermined relationship. Such matching of trading orders associated with related trading accounts is referred to herein as “in-house matching.”

In some embodiments, when a trading exchange receives from a particular trading account a new trading order that has a price that would trade with one or more contra trading orders currently on the exchange, the exchange determines whether any of such one or more contra trading orders are related to the new trading order by determining whether any of the one or more contra trading orders were received from trading accounts that have a particular relationship with the particular trading account. If any of such trading orders are determined to be related to the new trading order, the priority of each related trading order for being matched with the new trading order may be elevated above other, non-related trading order(s) having the same bid or offer price as that related trading order, regardless of the relative priority of that related trading order with respect to such other, non-related trading order(s) as defined by the relevant regular trading rules in the exchange. In other words, in determining which trading order(s) to match with the new trading order, trading order(s) determined to be related to the new trading order are matched with the new trading order before other, non-related trading order(s) at the same price are matched with the new trading order, regardless of the relative priority of the related trading order(s) and non-related trading order(s) as defined by the relevant regular trading rules in the exchange, such as the relative priority of the trading orders as determined by a price/time priority algorithm, a pro rata sharing algorithm, or by an auction protocol algorithm, for example. For example, where the trading exchange maintains trading orders in trading order lists (such as a buy order stack and a sell order stack, for example), a new trading order may be matched with one or more related contra trading orders in a trading order list on the exchange regardless of the position of such related trading order(s) in that trading order list with respect to other, non-related trading orders at the same price(s).

In some preferred embodiments, non-related trading orders at better prices than related trading orders may be matched before such related trading orders, however. In other words, the priority of a related trading order may not be elevated above non-related trading order(s) at a better price (i.e., more favorable to the new trading order) than the related trading order. In this manner, the trading entity placing the new trading order is protected from being financially disadvantaged by being matched and traded with the related trading order(s).

In this manner, related trading orders sent to the trading exchange may be “in-house matched” with each other before being matched with non-related trading orders at the same price. In some embodiments, the exchange matches (or attempts to match) related trading orders without breaking the existing, or regular, trading rules or logic of the exchange. Thus, related trading orders may be “in-house matched” with each other without breaking the existing, or regular, trading rules or logic of the exchange, or without breaking exchange or other governmental regulations. In addition, by submitting the trading orders to the trading exchange for matching, full price discovery of the exchange is still provided such that the fair market price of the exchange is realized for each trade.

Thus, traders who have placed trading orders which are then matched with new related trading orders by the in-house matching techniques discussed herein may have their orders filled faster than they would otherwise be filled. In addition, in some situations, if trading orders from the same or related entities are in-house matched on the exchange, the trade may be handled internally on the books of that entity, thus saving fees that would otherwise be assessed to the entity by the exchange.

In other embodiments, an electronic order routing system, or aggregator of markets, receives trading orders from various trading accounts and forwards such received trading orders often to a number of various trading exchanges using algorithms based on one or more various factors, such as the current real-time (or near real-time) pricing at each of the various trading exchanges, for example. The electronic order routing system may employ known routing algorithms and techniques, including algorithms for breaking up and distributing large orders to one or more electronic communications networks (ECNs) or exchange marketplaces, such as to avoid “spooking” the market with the large orders.

When the electronic order routing system receives from a particular trading account a new trading order that has a price that would trade with one or more contra trading orders previously routed by the electronic order routing system to the various trading exchanges, the electronic order routing system may determine whether any of such one or more contra trading orders are related to the new trading order by determining whether any of the one or more trading orders were received from trading accounts that have a particular relationship with the particular trading account. If the electronic order routing system determines that any of such trading orders are related to the new trading order, the electronic order routing system may send a cancellation request or command to the trading exchange(s) to which one or more of the related trading orders were previously routed to cancel at least a portion of such one or more related trading orders from that trading exchange. If the electronic order routing system receives confirmation that any portion (or all) of the related trading orders were indeed cancelled in response to the request or command sent by electronic order routing system, the electronic order routing system may then execute a trade between the new trading order and the portion (or all) of the related trading order(s) cancelled from the trading exchange, either facilitating clearance and settlement itself (such as in the case of an OTC bond trade, for instance), or registering the trade on one or more of the trading exchanges for such (such as in the case of a futures trade, for instance).

The registration of the “in-house matched” trade on a trading exchange may be subject to certain exchange rules of which the electronic order routing system may be cognizant when arranging such in-house matches. For example, in the case of a futures exchange, such registration of a futures trade matched off the exchange may only be possible if the match is above a certain size threshold, or if there is another physical instrument involved in the trading strategy of one or both of the related trading accounts that can be used as evidence for the futures trade match to be then accepted by the exchange under “Exchange for Physicals” rules used by many futures exchanges.

In this manner, the electronic order routing system can manage the in-house matching of related trading orders by attempting to match newly received trading orders with related trading orders previously routed to various trading exchanges before non-related trading orders at the same price(s) that were previously routed to such trading exchanges. In some embodiments, the electronic order routing system matches (or attempts to match) related trading orders without breaking the existing, or regular, trading rules or logic of the relevant trading exchanges. Thus, related trading orders may be “in-house matched” with each other without breaking the existing, or regular, trading rules or logic of the relevant trading exchanges.

Again, in some embodiments, non-related trading orders at better prices than related trading orders are still matched before such related trading orders, however. In other words, a related trading order will not be cancelled from a trading exchange in order to be traded with a new trading order if there are other, non-related trading order(s) at a better price (i.e., more favorable to the new trading order) than the related trading order. In this manner, the trading entity placing the new trading order is protected from being financially disadvantaged by being matched and traded with the related trading order(s). In addition, by routing trading orders to the trading exchange for matching, canceling previously routed trading orders to be matched with newly received trading orders, and matching the cancelled trading orders with the newly received trading orders, full price discovery of the various trading exchanges may be provided such that the fair market price of the exchanges may be realized for each trade.

In this manner, traders placing trading orders which are then matched with new related trading orders by the in-house matching techniques discussed herein may have their orders filled faster than they would otherwise be filled. In addition, in some situations, if trading orders from different traders within the same or related entities are in-house matched by the electronic order routing system, the trade may be handled internally on the books of legal entity, thus saving fees that would otherwise be assessed to the entity by an exchange or central clearing counterparty.

FIG. 1 illustrates an example trading system 10 for managing the matching of trading orders, including in-house matching of related trading orders, according to an embodiment of the present invention. As shown, system 10 may include one or more trading accounts 12 coupled to a trading exchange 14 by a communications network 16.

Trading accounts 12 may include any type of accounts from which trading orders 18 may be submitted to trading exchange 14. Trading accounts 12 may be associated with one or more trader entities 20. A trading entity 20 may include any entity that may participate in trading activity via trading system 10 using a trading account 12, such a broker 22 acting on behalf of a customer 24, indicated in FIG. 1 as a “customer/broker” relationship, a market maker 26, a fund or fund manager 28, a customer 24 acting on his own behalf, or any other suitable entity. A customer 24 may include an individual, group of individuals or firm that engages in trading activity via trading system 10, such as an individual investor, a group of investors, or an institutional investor, for example. A broker 22 may include individual, group of individuals or firm or firm that engages in trading activity via trading system 10 on behalf of one or more customers 24. In some situations, a broker 22 may also trade using its own account or accounts. A market maker 26 may include any individual, group of individuals or firm that submits and/or simultaneously maintains both buy and sell orders 18 for the same instrument on the trading exchange 14. A fund or fund manager 28 may include a mutual fund, a commodity trading advisor, a hedge fund, or an independent financial advisor, for example. In some embodiments, a particular trading account 12 may act as a proxy for multiple subsidiary trading accounts 12.

Particular trading accounts 12 may have relationships with other trading accounts 12 such that related trading accounts 12 may qualify for in-house matching with each other. Trading exchange 14 may designate the types of relationships between trading accounts 12 that may qualify for in-house matching. In some embodiments, trading exchange 14 may designate one or more of the following types of relationships between trading accounts 12 as qualifying for in-house matching: (a) two or more trading accounts 12 associated with the same legal entities (e.g., trading accounts 12 associated with the same company or companies within the same legal entity); (b) two or more trading accounts 12 associated with entities having a particular legal relationship, such as entities having a parent-subsidiary relationship, subsidiaries of the same parent organization, entities owned by or associated with the same holding company, or entities under contract for merger or acquisition, for example; or (c) two or more trading accounts 12 otherwise having a predetermined relationship recognized by trading exchange 14 as qualifying for in-house matching. It should be understood that these relationships discussed above are provided as examples only, and not by way of limitation, and that a trading exchange 14 may recognize any one or more particular types of relationships between trading accounts 12 as qualifying for in house matching.

Trading accounts 12 recognized by trading exchange 14 as qualifying for in-house matching are referred to herein as related trading accounts 12. As shown in FIG. 1, system 10 may include any number of groups 30 of related trading accounts 12 and any number of unrelated trading accounts 12. The trading accounts 12 within each group 30 are related to each other and thus may qualify for in-house matching with each other. Thus, for example, the trading accounts 12 within group 30a may qualify for in-house matching with each other, but not with the trading accounts 12 within group 30b. Similarly, the trading accounts 12 within group 30b may qualify for in-house matching with each other, but not with the trading accounts 12 within group 30a.

Trading orders 18 from related trading accounts 12, which therefore qualify for in-house matching by trading exchange 14, may be referred to as related trading orders 18. In addition, multiple trading orders 18 from the same trading account 12 (such as a matching buy order and sell order received from the same trading account 12, for example) may qualify for in-house matching by trading exchange 14.

Trading entities 20 may place various trading orders 18 onto trading exchange 14 via communications network 16. Trading exchange 14 may provide any suitable type of electronic trading exchange or marketplace for trading orders 18, such as for example, auction-type exchanges, entertainment-type exchanges, and electronic marketplaces for trading various financial instruments (such as stocks or other equity securities, bonds, mutual funds, options, futures, derivatives, swaps, and currencies, for example). Trading orders 18 may include buy orders 40, sell orders 42, or both, and may be any type of order which may be managed by a trading exchange 14, such as market orders, limit orders, day orders, open orders, GTC (“good till cancelled”) orders, “good through” orders, an “all or none” orders, or “any part” orders, stop orders, market-if-touched orders, for example and not by way of limitation. Each buy order 40 may have a bid price and size, while each sell order 42 may have an offer price and size.

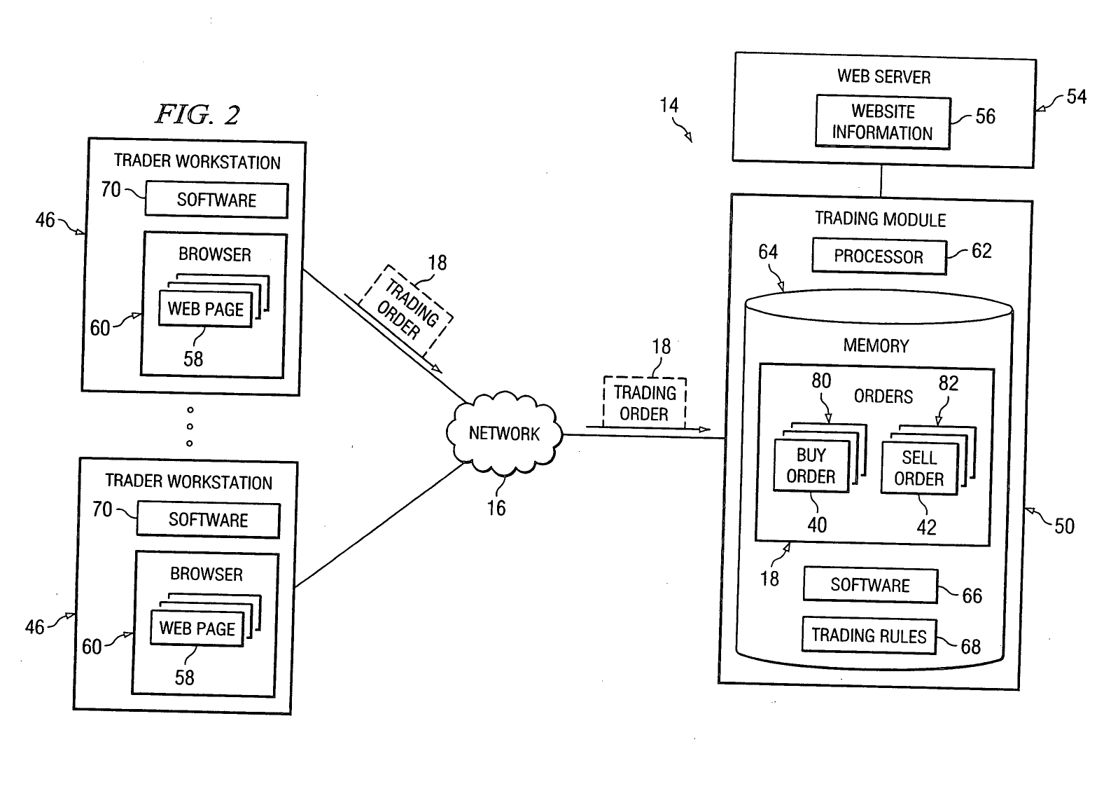

As discussed above, trading entities 20 may communicate with trading exchange 14 via network 16 in order to conduct trading activity from various trading accounts 12. A trading entity 20 may communicate with trading exchange 14 using a trader workstation 46, which is discussed below with regard to FIG. 2.

FIG. 2 illustrates an example configuration of trading system 10, including a number of trading workstations 46 coupled to trading exchange 14 via network 16. Trading workstations 46 provide trading entities 20 access for communicating with trading exchange 14 in order to conduct trading activity from various trading accounts 12. One or more trading entities may use a particular trading workstation 46 to conduct trading activity from one or more trading accounts 12. In addition, a particular trading entity may use one or more trading workstations 46 to conduct trading activity from one or more trading accounts 12.

A trader workstation 46 may include a computer system and appropriate software to allow trading entity 20 to engage in electronic trading activity on trading exchange 14 from one or more trading accounts 12. As used in this document, the term “computer” refers to any suitable device operable to accept input, process the input according to predefined rules, and produce output, for example, a personal computer, workstation, network computer, wireless data port, wireless telephone, personal digital assistant, one or more processors within these or other devices, or any other suitable processing device. A trader workstation 46 may include one or more human interface, such as a mouse, keyboard, game controller, or pointer, for example.

Communications network 16 is a communicative exchange operable to exchange data or information (including, for example, data defining trading orders 18 and various other messages) between trader workstations 12 and trading exchange 14. In a particular embodiment of the present invention, communications network 16 represents an Internet architecture. Alternatively, communications network 16 could be a plain old telephone system (POTS), which trading entities 20 could use to perform the same operations or functions. Such transactions may be assisted by a broker associated with trading exchange 14 or manually keyed into a telephone or other suitable electronic equipment in order to request that a transaction be executed. In other embodiments, communications system 14 could be any packet data network (PDN) offering a communications interface or exchange between any two nodes in system 10. Communications network 16 may alternatively be any local area network (LAN), metropolitan area network (MAN), wide area network (WAN), wireless local area network (WLAN), virtual private network (VPN), intranet, or any other appropriate architecture or system that facilitates communications in a network or telephonic environment.

Communications network 16 may facilitate real time telephonic voice conversations (for example, voice conversations communicated via IP telephony or POTS) wherein the voice of a person (such as a trading entity 20, broker, or other individual associated with trading system 10, for example) is encoded and/or digitized for communication via communications network 16. Communications network 16 may also facilitate the transfer of data, files, signaling and/or other digitized information. For the purposes of this document, “non-voice-based electronic data” includes all files, signaling and/or other digitized information, but specifically excludes real time voice conversations (such as encoded and/or digitized voice data), that may be communicated via communications network 16. In a particular embodiment, trading orders 18 (including buy orders 40 and sell orders 42) and trading-related messages between trading entities 20 and trading exchange 14 are communicated as non-voice-based electronic data. In other embodiments, some or all trading orders 18 and/or trading-related messages between trading entities 20 and trading exchange 14 are communicated via real time voice conversations.

Trading exchange 14 may comprise an electronic trading exchange or marketplace that facilitates the matching and trading of trading orders 18 from various trading accounts 12. Trading exchange 14 may include a trading module 50 comprising a computer, a server, a management center, a single workstation, or a headquartering office for any person, business, or entity that seeks to manage the trading of trading orders 18. Accordingly, trading module 50 may include any suitable hardware, software, personnel, devices, components, elements, or objects that may be utilized or implemented to achieve the operations and functions of an administrative body or a supervising entity that manages or administers a trading environment.

In some embodiments, trading exchange 14 may be associated with or comprise one or more web servers 54 coupled to trading module 50 and operable to store websites and/or website information 56 in order to host one or more web pages 58. Web servers 54 may be coupled to communication network 16 and may be partially or completely integrated with, or distinct from, trading exchange 14. A trading workstation 46 may include a browser application 60 operable to provide an interface to web pages 58 hosted by web servers 54 such that trading entities 20 may communicate information to, and receive information from, trading module 50 via communication network 16. In particular, browser application 60 may allow a trading entity 20 to navigate through, or “browse,” various Internet web sites or web pages 58 hosted by a web server 54 to provide an interface for communications between the trading entity 20 and trading exchange 14. For example, one or more web pages 58 may facilitate the communication of trading orders 18 and trading-related messages from trading entities 20 to trading exchange 14.

Trading exchange 14 may include a trading module 50 operable to receive trading orders 18 from trading entities 20 and to manage or process those trading orders 18 such that financial transactions among and between trading entities 20 may be performed. Trading module 50 may have a link or a connection to a market trading floor, or some other suitable coupling to any suitable element that allows for such transactions to be consummated.

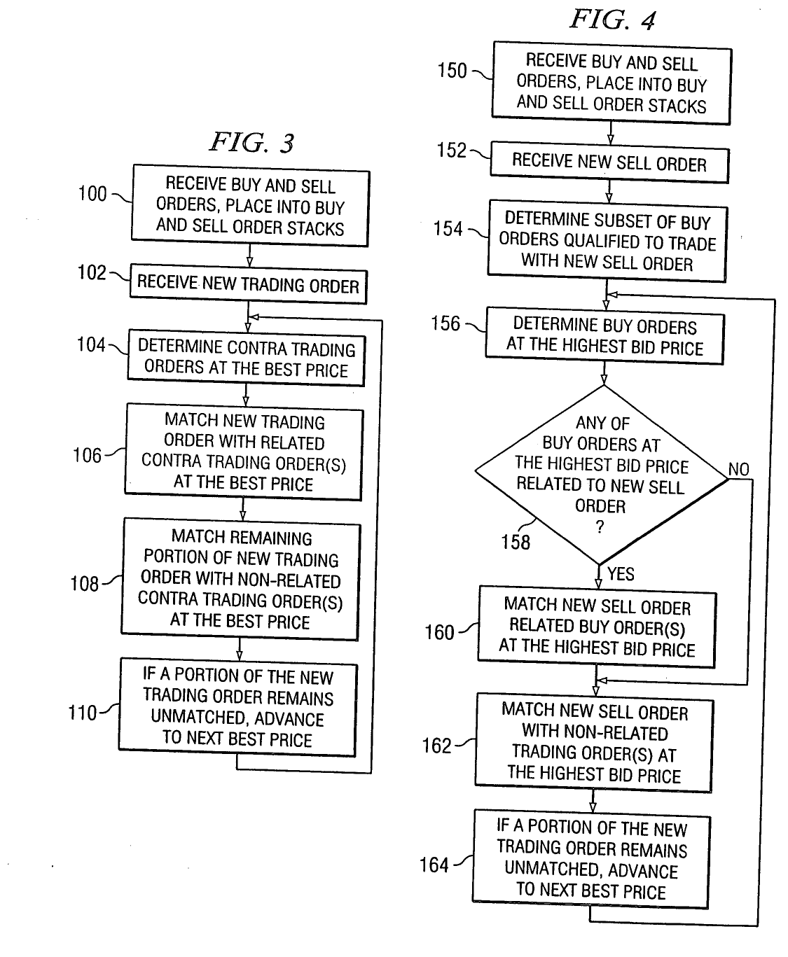

Trading module 50 may be operable to manage the matching of trading orders 12 received from various trading accounts 12 according to (a) one or more sets of trading rules or logic and (b) additional matching rules regarding the matching of related trading orders 12. Thus, trading module 50 may be able to identify related trading orders 12 and manage the matching of trading orders 12 accordingly, as discussed in greater detail below with reference to FIGS. 3-6.

As show in FIG. 1, trading module 50 may include a processing unit 62 and a memory unit 64. Processing unit 62 may process data associated with trading orders 18 or otherwise associated with trading system 10, which may include executing software 66 or other coded instructions that may in particular embodiments be associated with trading module 50. Memory unit 64 may store software 66, trading orders 18 received from trading entities 20, and one or more sets of trading management rules 68 that govern the matching and trading of various trading orders 18. Memory unit 64 may be coupled to data processing unit 62 and may include one or more databases and other suitable memory devices, such as one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), or any other suitable volatile or non-volatile memory devices.

It should be understood that the functionality provided by communications network 16 and/or trading module 50 may be partially or completely manual such that one or more humans may provide various functionality associated with communications network 16 or trading module 50. For example, a human agent of trading exchange 14 may act as a proxy or broker for placing trading orders 18 on trading exchange 14.

It should also be understood that although FIG. 1 illustrates a particular embodiment of the invention, some or all of the various automated functionality provided by system 10 discussed herein may be provided by any suitable hardware, software, or other computer devices located at, hosted by, or otherwise associated with any one or more components of system 10, including trader workstations 12, trading exchange 14, communications network 16, and web server 54. Such automated functionality may include any automated storage, processing, or communication of data associated with the following functions: generating, transmitting and receiving trading orders 18, determining whether particular trading orders 18 are related; managing the matching of trading orders 18; managing the execution of trades between trading orders 18; and maintaining and/or managing trading management rules 68. Different aspects of such functionality may be provided by different components of system 10.

In some embodiments, software 66 associated with trading module 50 of trading exchange 14 provides various functionality discussed herein, including for example, receiving trading orders 18 from trading entities 20, placing received trading orders 18 on an electronic trading exchange or marketplace such that the trading orders 18 may be executed, managing the priority of trading orders 18 (such as managing the promotion of trading orders within various trading order lists, for example), electronically determining whether particular trading orders 18 are related, and managing the matching of trading orders 18 based on trading management rules 68, and managing the execution of trades between trading orders 18.

In other embodiments, some of all of such functionality may be provided by software 70 located at, hosted by, or otherwise associated with any one or more trader workstations 12. For example, software 70 associated with a trader workstation 46 may be operable to perform the determination of related trading orders 18, which determination may then be used by trading module 50 in managing the matching of trading orders 18. For example, software 70 may be operable to receive electronic data input from a trading entity 20 defining a particular trading order 18, determine that one or more of the trading orders 18 currently on trading exchange 14 are related to the particular trading order 18, and electronically communicate to trading exchange 14 (a) the trading order 18 and (b) a notification identifying the one or more related trading orders 18. Trading module 50 may then use this notification as input (along with trading management rules 68) in managing the matching of the particular trading order 18 with one or more other trading orders 18 on the trading exchange 14.

As discussed above, trading module 50 may manage and process trading orders 18 based at least on electronic marketplace trading management rules 68. Trading management rules 68 may include various rules for managing the operation of trading exchange 14, such as, for example: rules or logic governing the matching of trading orders 18, including the matching of related trading orders 18; rules defining how to determine whether trading orders 18 are related; and rules defining how to manage the promotion of trading orders 18 within lists (such as queues or stacks) of such trading orders 18.

Trading management rules 68 may include (a) a set of “regular” trading rules or logic that generally govern the matching of trading orders 18 received by trading exchange 14, and (b) a set of “in-house matching” rules that govern the matching of related trading orders 12. The set of “regular” trading rules or logic may provide a price discovery process such that the current market price at trading exchange 14 is realized for trades between trading orders 18.

In some embodiments, the in-house matching rules are designed to supplement the regular trading rules, but not to affect the price discovery process provided by, or regulatory restrictions to, these regular trading rules. The in-house matching rules may be applied only at the point of trade, after the price discovery process provided by the regular trading rules has occurred. In particular embodiments, the in-house matching rules essentially provide that, for a newly received trading order, the priority of each related trading order for being matched with the new trading order is elevated above other, non-related trading order(s) having the same bid or offer price as the related trading order, regardless of the relative priority of the related trading order with respect to the other, non-related trading order(s) as defined by the relevant regular trading rules of the exchange. Non-related trading orders at better prices than related trading orders are still matched before such related trading orders, however. In other words, the priority of a related trading order may not be elevated above non-related trading order(s) at a better price (i.e., more favorable to the new trading order) than the related trading order.

Regular trading rules and in-house matching rules may work together in the following manner. At the point of trade for a new trading order, (1) one or more contra trading orders at the best price (i.e., the price most favorable to the new trading order) may be identified, (2) any of such one or more trading orders determined to be related to the new trading order (if any) may be matched with the new trading order, regardless of the priority of such related trading order(s) with respect to other, non-related trading order(s) at the best price as defined by the regular trading rules of the exchange, (3) if any portion of the new trading order remains, such portion may then be matched with the non-related trading order(s) at the best price (if any), (4) if any of portion of the new trading order still remains, steps (2) and (3) may be repeated at the next best price, and so on.

FIG. 3 illustrates the general cooperation between the regular trading rules and in-house matching rules of a trading exchange in matching related and/or non-related trading orders with a new trading order in accordance with particular embodiments of the invention. At step 100, trading orders 18 (such as buy orders 40 and sell orders 42) from various trading accounts 12 are received at trading exchange 14 from various trading entities 20, and prioritized according to the particular regular trading rules of trading exchange 14 by trading module 50. For example, received buy orders 40 and sell orders 42 may be placed into a buy order stack 80 and a sell order stack 82, respectively, for trading according to a price/time matching algorithm, or according to the algorithms disclosed in U.S. Pat. No. 6,560,580 issued on May 6, 2003, which is incorporated herein by reference, for example.

At step 102, a new trading order 18 (e.g. a new buy order 40 or sell order 42) is received by trading exchange 14. At step 104, of the various trading orders 18 existing on trading exchange 14, one or more contra trading orders 18 at the best price (i.e., the price most favorable to the new trading order) are identified. At step 106, if any of such contra trading orders 18 at the best price are related to the new trading order 18 (i.e., “related trading orders”), the new trading order 18 is first matched with one or more of such related trading order(s), regardless of the priority of such related trading order(s) with respect to other, non-related trading order(s) at the best price as defined by the regular trading rules of trading exchange 14. At step 108, if any portion of the new trading order 18 remains unmatched (or if there were no related trading orders 18 at the best price, and thus no matching performed at step 106), the new trading order 18 is matched with one or more non-related trading orders at the best price (if any exist).

At step 110, if any portion of the new trading order 18 still remains unmatched after being matched with related and/or non-related trading order(s) 18 at steps 106 and/or 108, the method returns and repeats steps 104-108. In particular, at step 104, one or more contra trading orders 18 at the next-best price (i.e., the next-most-favorable price to the new trading order other than the best price) are identified, and at steps 106 and 108, one or more related and/or non-related contra trading orders 18 are matched with any remaining portion of the new trading order 18. This process may repeat until either (a) all of the trading order 18 is matched with related and/or non-related contra trading orders 18 or (b) there are no remaining related and/or non-related contra trading orders 18 suitable to be matched with a remaining portion of new trading order 18, in which case the remaining portion of new trading order 18 may be placed on trading exchange 14 for subsequent trading.

Thus, the in-house matching rules may essentially circumvent the regular trading rules, but only such that application of the in-house matching rules does not break the regular trading rules to the detriment of the marketplace. As a result, customers or other entities financially associated with trading accounts 12 from which trading orders 18 are being matched and traded (which may or may not include the trading entities 20 engaging in trading activity from such trading accounts 12) will not be financially disadvantaged by the in-house trading rules.

In some embodiments, one, some or all of the steps of the method discussed above may be performed electronically without intentionally implemented delay. As used herein, an “intentionally implemented delay” may include intentional delays included in the trading process, such as timed delays for receiving input (from trading entities 20 or other sources) that may affect the relevant trading process. For example, an intentionally implemented delay may include a predetermined period of time during which input may be received that may affect the determination of which one or more trading orders 18, or the particular sizes or pro rate portions of one or more trading orders 18, that will trade with a contra trading order 18. “Intentionally implemented delays” may exclude delays inherent in a computerized trading process or inherently associated with an electronic trading exchange, such as delays inherently associated with performing computerized calculations or executing other computerized processes, for example.

In some embodiments, at least steps 104 through 108 of the method discussed above are performed in sequence without intentionally implemented delay. In addition, step 110 may also be performed without intentionally implemented delay. In other embodiments, one or more of steps 104 through 110 may include one or more intentionally implemented delays.

Various example embodiments of trading management rules 68 are discussed below.

Applying In-House Matching Rules with Price/Time Priority Regular Trading rules.

In some embodiments, trading management rules 68 generally provide for applying in-house matching rules with price/time priority regular trading rules, such as the various price/time priority trading rules described in U.S. Pat. No. 6,560,580 issued on May 6, 2003, which is incorporated herein by reference. Price/time priority generally refers to the priority assigned to trading orders 18 received at a trading exchange 14 based on the price of each trading order 18 (the better price, the higher the priority), and for multiple trading orders 18 having the same price, based on the respective time that each of such multiple trading orders 18 was received at the trading exchange 14 (the earlier received, the higher the priority). Thus, suppose five buy orders 40 are received at the trading exchange 14 in the following time order, from earliest received to most recently received: Order 1: Buy 30 at 27.95; Order 2: Buy 15 at 27.97; Order 3: Buy 20 at 27.96; Order 4: Buy 15 at 27.95; Order 5: Buy 25 at 27.97. According to price/time priority, the five buy orders 40 would be placed in a buy order stack 80 in the following order, from highest priority (top) to lowest priority (bottom):
Buy 15 at 27.97 (Order 2)
Buy 25 at 27.97 (Order 5)
Buy 20 at 27.96 (Order 3)
Buy 30 at 27.95 (Order 1)
Buy 15 at 27.95 (Order 5)

Price/time priority regular trading rules generally provide that trading orders on a trading exchange 14 are traded with contra trading orders in order of relative price/time priority of such trading orders. The trading orders at the best price are traded with matching contra trading orders, in order of time priority (the earliest received trading order at the best price will trade first, followed by the next earliest received trading order at the best price, and so on), followed by the trading orders at the second best price, again in order of time priority, followed by the trading orders at the third best price, again in order of time priority, and so on. Thus, in the example buy order stack listed above, Buy Orders 1-5 would be traded in order going down buy order stack 80. Thus, supposing a new sell order, Sell 40 at 27.95, Buy Orders 2 and 5 at the best (highest) bid price would trade with the new sell order, despite the fact that Buy Orders 3 and 1 have a bid price suitable to trade with the new sell price and were received before Buy Order 5.

FIG. 4 illustrates an example method of applying such trading management rules 68, including applying in-house matching rules with price/time priority regular trading rules, in a particular embodiment of the invention. It should be understood that although the following discussion involves a new sell order 42 being received at trading exchange 14 and matched with one or more buy orders 40, the same or similar principles apply equally to situations in which a new buy order 40 is received at trading exchange 14 and matched with one or more sell orders 42.

In general, trading orders 18 in a trading order stack are traded with contra trading orders 18 in order according to price/time priority, except that related trading orders (i.e., trading orders that are related to the relevant contra trading orders) are traded before non-related trading orders at the same price (but not before non-related trading orders at a better price). Thus, a trading account 12 may be protected from being financially disadvantaged by having trading orders 18 being matched and traded with related trading orders 18 at prices less favorable to the trading account 12 than other, non-related trading orders 18.

At step 150, buy orders 40 and sell orders 42 from various trading accounts 12 are received at trading exchange 14 from various trading entities 20 via various trader workstations 46. The received buy orders 40 and sell orders 42 are placed into a buy order stack 80 and a sell order stack 82, respectively, by trading module 50 according to price/time priority matching principals defined by the regular trading rules of trading management rules 68, such as discussed above.

At step 152, a new sell order 42 is received from a particular trading account 12. At step 154, trading module 50 applies trading management rules 68 to determine, based on the offer price of the new sell order 42 and the bid prices of the buy orders 40 currently in the buy order stack 80, that a subset of one or more of the buy orders 40 currently in the buy order stack 80 qualify to match with the new sell order 42. At step 156, trading module 50 identifies one or more buy orders 40 at the highest bid price (i.e., the price most favorable to the new trading order). At step 158, at this point (the point of trade), trading module 50 applies in-house matching rules to determine whether any of such buy order(s) 40 at the highest bid price are related to the new sell order 42. This determination may involve determining whether the trading accounts 12 from which each buy order 40 was placed is/are related to the particular trading account 12 associated with the new sell order 42.

If at least one of the buy orders 40 at the highest bid price is related to the new sell order 42, at step 160, trading module 50 applies the in-house matching rules to match the new sell order 42 with one or more of the related buy order(s) 40 at the highest bid price (depending on the relative sizes of the new sell order 42 and each of the related buy orders 40), regardless of the relative priority of such related buy order(s) 40 with respect to other, non-related buy order(s) 40 at the highest bid price, as determined according to the price/time priority regular trading rules. Trading module 50 may match the new sell order 42 with related buy orders 40 according to the price/time priority regular trading rules (as applied only to the related buy orders 40 at the highest bid price). In some embodiments, steps 154 through 160 are performed in sequence without intentionally implemented delay. In other embodiments, one or more of steps 154 through 160 may include one or more intentionally implemented delays.

Thus, for example, trading module 50 may first match new sell order 42 with the related buy order 40 nearest the top (or front) of the buy order stack 80 (i.e., the earliest received related buy order 40 at the highest bid price) for a first trade. If any portion of the new sell order 42 remains after being matched with the highest-priority related buy order 40, trading module 50 may match the remaining portion of the new sell order 42 with the related buy order 40 next nearest the top (or front) of the buy order stack 80 (i.e., the next earliest received related buy order 40 at the highest bid price) for a second trade, and so on. The new sell order 42 may be matched with related buy order(s) 40 at the highest bid price until either (a) the full size of the new sell order 42 has been matched with such related buy orders 40 at the highest bid price; or (b) no more related buy orders 40 at the highest bid price remain to match with a remaining portion of the new sell order 42, in which case the remaining portion of the new sell order 42 may then be traded with one or more non-related trading orders 40 at the highest bid price, as discussed below.

If either (a) none of the buy order(s) 40 at the highest bid price are related to the new sell order 42 or (b) a portion of the new sell order 42 remains after being matched with related buy order(s) 40 at the highest bid price (as discussed above), new sell order 42 may then be traded with one or more non-related trading orders 40 at the highest bid price at step 162. In particular, trading module 50 may apply the regular trading rules based on price/time priority matching principals to match the new sell order 42 with one or more of the buy orders 40 at the highest big price, depending on the relative sizes of the new sell order 42 and each of such buy orders 40. Thus, for example, trading module 50 may first match new sell order 42 with the non-related buy order 40 nearest the top (or front) of the buy order stack 80 (i.e., the earliest received non-related buy order 40 at the highest bid price) for a first trade. If any portion of the new sell order 42 remains after being matched with the highest-priority non-related buy order 40, trading module 50 may match the remaining portion of the new sell order 42 with the non-related buy order 40 next nearest the top (or front) of the buy order stack 80 (i.e., the next earliest received non-related buy order 40 at the highest bid price) for a second trade, and so on. The new sell order 42 may be matched with non-related buy order(s) 40 at the highest bid price until either (a) the full size of the new sell order 42 has been matched with such non-related buy orders 40 at the highest bid price; or (b) no more non-related buy orders 40 at the highest bid price remain to match with a remaining portion of the new sell order 42, in which case the remaining portion of the new sell order 42 may then be traded with related and/or non-related trading order(s) 40 at one or more lower bid prices, as discussed below.

If any portion of the new sell order 42 remains after being matched with related and/or non-related buy order(s) 40 at the highest bid price, at step 164, trading module 50 may match the remaining portion of the new sell order 42 with related and/or non-related trading order(s) 40 at one or more lower bid prices. In particular, for each progressively lower bid price, trading module 50 may repeat steps 156-162 discussed above. Thus, trading module 50 may repeat step 156 to identify one or more buy orders 40 at the second highest bid price currently existing in buy order stack 80. Trading module 50 may then repeat step 158 to apply in-house matching rules to determine whether any of such buy order(s) 40 at the second highest bid price are related to the new sell order 42. In some embodiments, such determination may be made at other times. For example, trading module 50 may determine at one time whether each buy order 40 in buy order stack 80 is related to new sell order 42. As another example, trading module 50 may determine at one time whether each buy order 40 in buy order stack 80 having a price suitable to trade with the new sell order 42 is related to new sell order 42. Trading module 50 may then repeat steps 160 and 162 to trade new sell order 42 with related and/or non-related trading order(s) 40 at the second highest bid price.

Trading module 50 may continue to repeat steps 156-162 for progressively lower bid prices until either (a) the full size of the new sell order 42 has been matched with related and/or non-related buy orders 40; or (b) there are no more buy orders 40 remaining in buy order stack 80 qualified to trade with a remaining portion of new sell order 42, in which case trading module 50 may place the remaining portion of new sell order 42 on trading exchange 14 for subsequent trading. In some embodiments, steps 154 through 164 (which may include one or more repetitions of steps 156-162) are performed in sequence without intentionally implemented delay. In other embodiments, one or more of steps 154 through 164 may include one or more intentionally implemented delays.

### EXAMPLE 1

An example of the application of trading management rules 68 discussed above with reference to FIG. 4 is provided as follows. At step 150, buy orders 40 and sell orders 42 at trading exchange 14 from various trading accounts 12 and placed into a buy order stack 80 and a sell order stack 82 according to price/time priority such that the following buy order stack 80 and sell order stack 82 exist at a particular point in time:

| Buy Orders | | | | Sell Orders | | | |
|---|---|---|---|---|---|---|---|
| Order # | Price | Size | Account | Order # | Price | Size | Account |
| 1 | 27.97 | 5 | A | 6 | 27.98 | 10 | F |
| 2 | 27.97 | 10 | B | 7 | 27.98 | 5 | G |
| 3 | 27.96 | 5 | C | 8 | 27.98 | 20 | H |
| 4 | 27.96 | 10 | D | 9 | 27.99 | 15 | I |
| 5 | 27.95 | 15 | E | 10 | 28.00 | 5 | J |

At step 152, a New Sell Order of 27.96×20 is received from trading account K. Suppose for the purposes of this discussion that Accounts B and D are related to account K. Thus, Buy Orders 2 and 4 are related to the New Sell Order.

At step 154, trading module 50 applies trading management rules 68 to determine, based on the offer price of the New Sell Order (27.96) and the bid prices of the buy orders currently in buy order stack, that a subset of the buy orders currently in the buy order stack qualify to match with the New Sell Order. Here, trading module 50 determines that Buy Orders 1-4 qualify (price=27.96) to match with the New Sell Order (price=27.96). Thus, Buy Orders 1-4 comprise the subset of buy orders qualified to trade with the New Sell Order.

At step 156, trading module 50 identifies Buy Orders 1 and 2 at the highest bid price (27.97). At step 158, at this point (the point of trade), trading module 50 applies in-house matching rules to determine whether Buy Orders 1 or 2 are related to the New Sell Order by determining whether the trading accounts corresponding with either of Buy Orders 1 and 2 (Accounts A and B) are related to the trading account 12 associated with the New Sell Order (Account K).

As discussed above, trading module 50 determines that Buy Order 2 (but not Buy Order 1) is related to the New Sell Order at step 160. Thus, trading module 50 applies the in-house matching rules to create a first match between the New Sell Order and the related Buy Order 2. In particular, trading module 50 matches ten units of New Sell Order with the ten units of Buy Order 2.

Trading module 50 then creates a second match between the New Sell Order and non-related Buy Order 1 at step 162. In particular, trading module 50 matches five units of New Sell Order with the five units of Buy Order 1. After being matched with Buy Orders 1 and 2, five units of the New Sell Order remain to be traded.

As discussed above, after matching the New Sell Order with related and/or non-related buy orders 40 at the highest bid price (i.e., Buy Orders 1 and 2 at 27.97), trading module 50 may match the remaining portion (five units) of the New Sell Order at one or more lower bid prices. Thus, trading module 50 may advance to the next lowest bid price in the buy order stack, 29.96, and repeat steps 156-162 in order to match the remaining portion (five units) of the New Sell Order. Thus, trading module 50 may repeat step 156 to identify Buy Orders 3 and 4 at the second highest bid price, 29.96. Trading module 50 may then repeat step 158 to apply in-house matching rules to determine whether Buy Orders 3 or 4 are related to the New Sell Order by determining whether the trading accounts corresponding with either of Buy Orders 3 and 4 (Accounts C and D) are related to Account K associated with the New Sell Order.

As discussed above, trading module 50 determines that Buy Order 4 (but not Buy Order 2) is related to the New Sell Order at step 160. Thus, trading module 50 applies the in-house matching rules to create a third match between the New Sell Order and the related Buy Order 4. In particular, trading module 50 matches the remaining five units of New Sell Order with five of the ten units of Buy Order 4. The remaining five units of Buy Order 4 may remain in position in buy order stack 80.

Applying In-House Matching Rules with Temporary Trading Exclusivity Regular Trading Rules.

In some embodiments, trading management rules 68 may also generally provide for applying in-house matching rules with regular trading rules based both on price/time priority and an initial trading exclusivity awarded to those trading orders at the front of a particular trading order stack during matching, for trading entities associated with particular trading orders 18. Example trading rules with such trading exclusivity are disclosed in U.S. Pat. No. 6,560,580, incorporated herein by reference, as discussed above. As discussed above, price/time priority regular trading rules generally provide that trading orders 18 received at a trading exchange 14 are assigned priority based on the price of each trading order 18 (the better price, the higher the priority), and for multiple trading orders 18 having the same price, based on the respective time that each of such multiple trading orders 18 was received at the trading exchange 14 (the earlier received, the higher the priority). Trading rules that provide initial trading exclusivity periods for trading entities 20 associated with particular trading orders 18 may include, for example, rules providing that the trading entity 20 having the current highest-priority trading order (according to price/time priority) in a trading order stack may have a temporary exclusive period during which to trade with a new contra trading order, after which other trading entities 20 may trade with the new contra trading order (if at least a portion of the new contra trading order remains). As another example, such trading rules may provide that the trading entities 20 associated with each trading order 18 at the best price in a trading order stack may have a temporary exclusive period during which to trade with a new contra trading order.

During a temporary exclusive trading period, only the one or more particular trading entities 20 may trade with the new trading order. In situations where other trading entities 20 may attempt to trade with the new trading order during the temporary exclusive trading period, such attempted trades may be queued waiting to trade, and later implemented if at least a portion of the new trading order remains after the temporary exclusive trading period. Temporary exclusive trading periods may have any suitable predetermined duration, such as a few seconds, for example, and may also be truncated by certain actions of the trading entity 20, such as cancellation of their remaining trading order 18, for example.

In such embodiments in which in-house matching rules are incorporated with such temporary exclusive trading rules, the in-house matching rules may elevate the priority of a related trading order 18 such that the related trading order 18 may benefit from the temporary exclusive trading rules over other, non-related trading orders 18 at the same price that may have otherwise been assigned a higher priority than the related trading order 18 based on the regular price/time priority rules.

In one example embodiment, the regular exclusive trading rules may provide that the highest-priority trading order (according to price/time priority) in a trading order stack may be given an initial exclusive period during which to trade with a new contra trading order, after which other trading orders in the stack may trade with the new contra trading order (if at least a portion of the new contra trading order remains). However, the in-house matching rules may provide that a related trading order at the best price in the trading order stack is elevated in priority and granted the initial exclusive period instead of a non-related trading order at the top of the trading order stack (and at the same price as the related trading order). Alternatively, both the highest-priority trading order (according to price/time priority) in the stack and each related trading order at the best price (but not non-related trading orders at the best price but not at the top of the stack) may be granted the initial exclusive period during which to trade with the new contra trading order.

Thus, suppose the following buy order stack 80 exists at a trading exchange 14, in which the buy orders 40 are prioritized in the stack 80 according to price/time priority from highest priority (top) to lowest priority (bottom):
1. Buy 15 at 27.96 (Buy Order 1, Account 1)
2. Buy 5 at 27.96 (Buy Order 2, Account 2)
3. Buy 5 at 27.96 (Buy Order 3, Account 3)
4. Buy 15 at 27.95 (Buy Order 4, Account 4)

Suppose that a New Sell Order, “Sell 20 at 27.97,” is received at the trading exchange 14 from Account 5. Further suppose that Account 2 is related to Account 5 (but none of Accounts 1, 3 or 4 are related to Account 5). Thus, according to the temporary exclusive trading rules of this example embodiment, Buy Order 1 would be given an initial exclusive period during which to trade with the New Sell Order, after which Buy Orders 2, 3 and/or 4 may be permitted to trade with the new contra trading order (if at least a portion of the New Sell Order remains). However, with the incorporation of the in-house trading rules, related Buy Order 2 (rather than non-related Buy Order 1) may be given the initial exclusive period during which to trade with the New Sell Order, after which Buy Orders 1, 3 and/or 4 may be permitted to trade with the new contra trading order (if at least a portion of the New Sell Order remains).

In another example embodiment, the regular exclusive trading rules may provide that (a) each trading order at the best price (i.e., most favorable to a contra trading order) in a trading order stack is immediately (or substantially immediately) traded with a new contra trading order having a price appropriate to trade with such trading order(s) at the best price; and (b) if a portion of the new contra trading order remains after the initial immediate trades with the trading order(s) at the best price, the trading account associated with the highest-priority trading order (i.e., the trading order at the top of the relevant trading order stack) is granted an initial exclusive period during which to trade with the remaining portion of the new contra trading order. However, the in-house matching rules may provide that a trading account associated with a related trading order at the best price in the trading order stack is elevated in priority and granted the initial exclusive period instead of a trading account associated with the non-related trading order at the top of the trading order stack (and at the same price as the related trading order). Alternatively, trading accounts associated with both the highest-priority trading order (according to price/time priority) in the stack and each related trading order at the best price may be granted the initial exclusive period during which to trade with the remaining portion of the new contra trading order.

In yet another example embodiment, the trading rules 68 may provide that regardless of which trading account(s) are granted an initial exclusive period during which to trade with a new contra trading order from a particular trading account, trading accounts related to the particular trading account, regardless of whether such related trading accounts had an existing trading order at the best price when the new contra trading order was received, may be allowed to trade with the new contra trading order during the initial exclusive period, thus circumventing the regular exclusive trade rules.

Thus, in the example discussed above, suppose a new sell order, “Sell 20 at 27.96,” is received at the trading exchange 14 from Account 5. The exclusive trading rules in this embodiment may provide that the highest-priority buy order (Buy Order 1) and related buy orders (Buy Order 2) at the highest bid price would trade immediately with the new sell order, leaving 5 units of the new sell order remaining untraded. The highest-priority buy order (Buy Order 1) may then enjoy a brief initial exclusive period to decide whether to trade the further surplus of 5 units of the new sell order, to the temporary exclusion of anybody subsequently attempting to buy that surplus 5 units. Thus, according to such exclusive trading rules, Buy Order 1 is given an initial exclusive period during which to trade the surplus 5 units, after which any other buy orders at the 27.96 bid price may be permitted to trade with the surplus 5 units for sale. However, with the incorporation of the in-house trading rules, any subsequent buy order at 27.96 or higher bid price received at trading exchange 14 from a related trading account (i.e., related to Account 5), regardless of whether such. related trading account had an existing buy order at 27.96 bid price when the new sell order was received, is allowed to circumvent the exclusive period and trade immediately with the surplus 5 units for sale.

Indeed at all stages of such a trade using exclusive matching rules, related accounts queued waiting to trade while the exclusive periods are in operation may be able to achieve earlier executions, permitted by the in-house matching rules not waiting for the expiry of the exclusive periods and providing an execution with contra related accounts immediately.

Applying In-House Matching Rules with “Trading Through the Stack” Trading Rules.

In some embodiments, trading management rules 68 generally provide for applying in-house matching rules with “trading through the stack” regular trading rules. These trading rules may be used in addition to, or instead of, the exclusive matching rules detailed and referenced above. Such “trading through the stack” trading rules generally provide that when a particular trading order 18 to be traded with multiple contra trading orders 18 is larger than the total of contra trading orders 18 at the current best price, the excess portion of the particular trading order 18 is offered to the market at that current best price for a period of time. If a portion of the particular trading order 18 remains untraded after the period of time, the portion of the particular trading order 18 is traded with one or more contra trading orders 18 at the best available price(s).

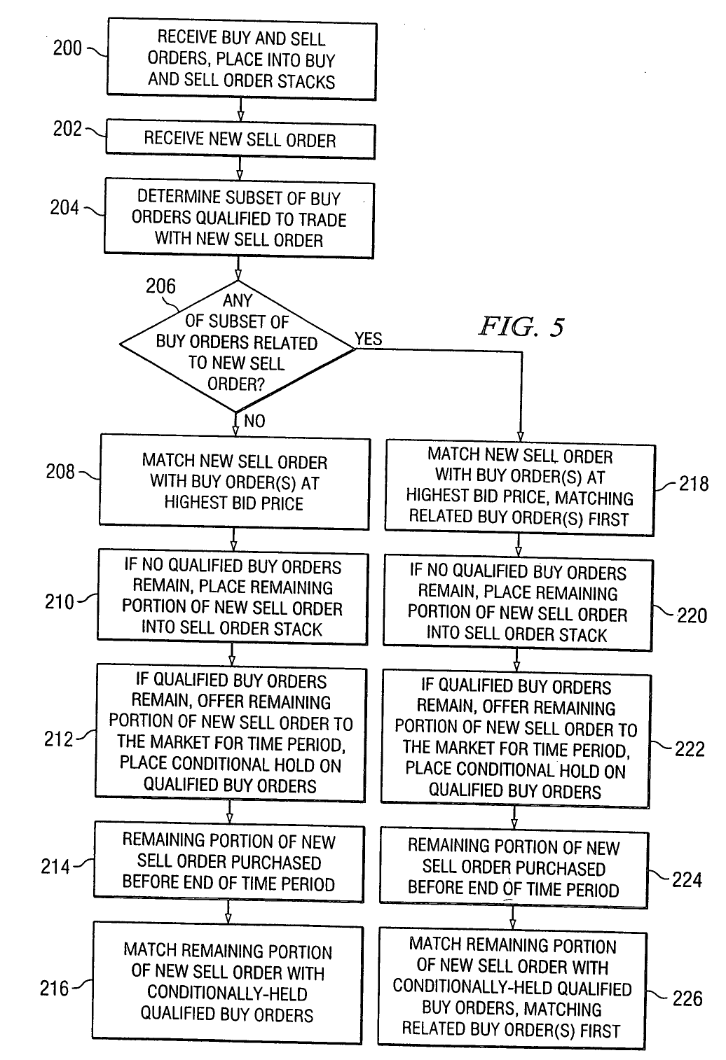

FIG. 5 illustrates an example method of applying such trading management rules 68 in a particular embodiment of the invention. It should be understood that although the following discussion involves a new sell order 42 being received at trading exchange 14 and matched with one or more buy orders 40, the same or similar principals apply equally to situations in which a new buy order 40 is received at trading exchange 14 and matched with one or more sell orders 42.

At step 200, buy orders 40 and sell orders 42 from various trading accounts 12 are received at trading exchange 14 from various trading entities 20 via various trader workstations 46. The received buy orders 40 and sell orders 42 are placed into a buy order stack 80 and a sell order stack 82, respectively, by trading module 50 according to price/time priority principals defined by the regular trading rules of trading management rules 68.

At step 202, a new sell order 42 is received from a particular trading account 12. At step 204, trading module 50 applies trading management rules 68 to determine, based on the offer price of the new sell order 42 and the bid prices of the buy orders 40 currently in the buy order stack 80, that a subset of one or more of the buy orders 40 currently in the buy order stack 80 qualify to match with the new sell order 42. At step 206, at this point (the point of trade), trading module 50 applies in-house matching rules to determine whether any of the subset of buy orders 40 qualified to match with the new trading order 18 are related to the new sell order 42. This determination may involve determining whether the trading accounts 12 from which each of the subset of buy orders 40 were placed are related to the particular trading account 12 associated with the new sell order 42.

If it is determined at step 206 that none of the subset of buy orders 40 qualified to match with the new trading order 18 are related to the new sell order 42, at steps 208-216, trading module 50 applies the “trading through the stack” trading rules to match the new sell order 42 with one or more of the subset of qualified buy orders 40. First, at step 208, trading module 50 matches new sell order 42 with one or more buy orders 40 at the highest bid price in the buy order stack 80, in time priority order (i.e., earlier received orders have higher priority), for one or more first trades. Thus, if there are multiple buy orders 40 at the highest bid price in the buy order stack 80, trading module 50 matches new sell order 42 with such buy orders 40 in price/time priority order. The bid price of the buy orders 40 (which may be greater than the offer price of the new sell order 42) determines the trade price for the one or more matches determined at step 208. In some embodiments, steps.204 through 208 are performed in sequence without intentionally implemented delay. In other embodiments, one or more of steps 204 through 208 may include one or more intentionally implemented delays.

If a portion of the new sell order 42 remains after being matched with the buy order(s) 40 at the highest bid price in the buy order stack 80, but none of the remaining buy orders 40 in buy order stack 80 have a price qualified to match with that of the new sell order 42, trading module 50 places the remaining portion of the new sell order 42 into the sell order stack 82 on the trading exchange 14, according to price/time priority order, at step 210.

Alternatively, if a portion of the new sell order 42 remains after being matched with the buy order(s) 40 at the highest bid price in the buy order stack 80, and one or more of the remaining buy orders 40 in buy order stack 80 have a price qualified to match with that of the new sell order 42, trading module 50 offers the remaining portion of the new sell order 42 to the market at the highest bid price in the buy order stack, including the buy orders matched with the new sell order at step 208, for a determined period of time at step 212. In some embodiments, a conditional hold may be placed on one or more remaining buy orders 40 in buy order stack 80 having a price qualified to match with the new sell order 42. The conditional hold may be placed on one or more of such qualified buy orders 40 to the extent of the size of the remaining portion of the new sell order 42. For example, if the remaining portion of the new sell order 42 (i.e., after the one or more matches at step 208) is 45 units, a conditional hold may be placed on a total of 45 units of qualified buy orders 40, if available. The conditional hold prevents the buy orders 40 being held from being cancelled until either (a) the determined period of time for offering the remaining portion of the new sell order 42 to the market expires, or (b) one or more buy orders 40 are received, during the determined period of time, to purchase the remaining portion of the new sell order 42 being offered to the market at the highest bid price.

Thus, if one or more buy orders 40 to purchase the remaining portion of the new sell order 42 at the highest bid price are received during the determined period of time, the remaining portion of the new sell order 42 may be purchased at the highest bid price and the conditional holds on the other qualified buy: orders 40 may be released, at step 214. The conditional hold may also be removed or truncated in some circumstances, whereby immediate trades with one or more of buy orders 40 may be initiated. Such cases may include, but not be limited to, cancellation of the held orders without additional size being available to satisfy the required trade match at that price level; or other orders canceling such that the ability of the trading rules to ensure a trade match will occur may be compromised.

Alternatively, if the determined period of time for offering the remaining portion of the new sell order 42 at the highest bid price expires before being purchased at that price, the remaining portion of the new sell order 42 is matched with the one or more conditionally-held qualified buy orders 40, in price/time priority order, each match being made at the price of the respective buy order 40, at step 216.

However, if it is determined at step 206 that one or more of the subset of buy orders 40 qualified to match with the new trading order 18 are related to the new sell order 42, at steps 218-226, trading module 50 applies the “in house” matching rules to the “trading through the stack” trading rules to match the new sell order 42 with one or more of the subset of qualified buy orders 40. Such qualified buy orders 40 that are determined to be related to the new sell order 42 may be referred to as related buy orders 40.

First, at step 218, trading module 50 matches new sell order 42 with one or more buy orders 40 at the highest bid price in the buy order stack 80 for one or more first trades. In determining such match(es), trading module 50 first matches new sell order 42 with any related buy order 40 having the highest bid price in the buy order stack 80, in time priority order. If any portion of the new sell order 42 remains after being matched with any related buy orders at the highest bid price, trading module 50 then matches new sell order 42 with the remaining (unrelated) buy orders 40 having the highest bid price in the-buy order stack 80, in time priority order, beginning at the top of the buy order stack 80. The bid price of the buy orders 40 (i.e., the highest bid price in buy order stack 80, which may be greater than the offer price of the new sell order 42) determines the trade price for the one or more matches determined at step 218. Each trade between the new sell order 42 and a related buy order 40 is an in-house trade and may thus qualify for the benefits of in-house trading discussed herein, such as reduced or eliminated clearing fees, for example. In some embodiments, steps 204, 206 and 218 are performed in sequence without intentionally implemented delay. In other embodiments, one or more of steps 204, 206 and 218 may include one or more intentionally implemented delays.

If a portion of the new sell order 42 remains after being matched at step 218 with the related and/or unrelated buy order(s) 40 at the highest bid price in the buy order stack 80, but none of the remaining buy orders 40 in buy order stack 80 have a price qualified to match with that of the new sell order 42, trading module 50 places the remaining portion of the new sell order 42 into the sell order stack 82 on the trading exchange 14, according to price/time priority order, at step 220.

Alternatively, if a portion of the new sell order 42 remains after being matched with the related and/or unrelated buy order(s) 40 at the highest bid price in the buy order stack 80, and one or more of the remaining buy orders 40 in buy order stack 80 have a price qualified to match with that of the new sell order 42, trading module 50 offers the remaining portion of the new sell order 42 to the market at the highest bid price in the buy order stack, including the buy orders matched with the new sell order at step 208, for a determined period of time at step 222. A conditional hold may be placed on one or more remaining buy orders 40 in buy order stack 80 having a price qualified to match with the new sell order 42, as discussed above regarding step 212. The conditional hold may be placed on one or more of such qualified buy orders 40 to the extent of the size of the remaining portion of the new sell order 42. As discussed above, a conditional hold prevents the buy orders 40 being held from being cancelled until either (a) the determined period of time for offering the remaining portion of the new sell order 42 to the market expires, or (b) a buy order is received, during the determined period of time, to purchase the remaining portion of the new sell order 42 being offered to the market at the highest bid price. A conditional hold may be placed on both related and unrelated buy orders 40. In particular embodiments, whether or not a buy order 40 is related to the new sell order 42 does not affect trading module 50's management of placing or releasing conditional holds on buy orders 42.

If one or more buy orders 40 to purchase the remaining portion of the new sell order 42 at the highest bid price are received during the determined period of time, the remaining portion of the new sell order 42 may be purchased at the highest bid price and the conditional holds on the other qualified buy orders 40 (which may or may not include one or more related buy orders 40) may be released, at step 224.

Alternatively, if the determined period of time for offering the remaining portion of the new sell order 42 at the highest bid price expires before being purchased at that price, the remaining portion of the new sell order 42 is matched with the one or more conditionally-held qualified buy orders 40 (which may or may not include one or more related buy orders 40), in price/time priority order and according to the in-house matching rules, each match being made at the price of the respective buy order 40, at step 226. Thus, the remaining portion of the new sell order 42 is matched with the conditionally-held qualified buy orders 40 in order from highest-to-lowest price (i.e., following price/time priority rules), but if one or more conditionally-held related buy orders 40 and one or more conditionally-held unrelated buy orders 40 exist at the same price, the remaining portion of the new sell order 42 will be matched with the related buy order(s) 40 before the unrelated buy order(s) 40 (i.e., following in-house matching rules). Again, each trade between the new sell order 42 and a related buy order 40 is an in-house trade and may thus qualify for the benefits of in-house trading discussed herein, such as reduced or eliminated clearing fees, for example.

### EXAMPLE 2

An example of the application of trading management rules 68 discussed above with reference to FIG. 5 is provided as follows. At step 200, buy orders 40 and sell orders 42 are received at trading exchange 14 from various trading accounts 12 and placed into a buy order stack 80 and a sell order stack 82 according to price/time priority protocols such that the following buy order stack 80 and sell order stack 82 exist at a particular time:

| Buy Orders | | | | Sell Orders | | | |
|---|---|---|---|---|---|---|---|
| Order # | Price | Size | Account | Order # | Price | Size | Account |
| 1 | 27.97 | 5 | A | 11 | 27.98 | 10 | L |
| 2 | 27.97 | 5 | B | 12 | 27.98 | 5 | M |
| 3 | 27.97 | 10 | C | | | | |
| 4 | 27.97 | 15 | D | | | | |
| 5 | 27.96 | 5 | E | | | | |
| 6 | 27.96 | 10 | F | | | | |
| 7 | 27.95 | 10 | G | | | | |
| 8 | 27.95 | 10 | H | | | | |
| 9 | 27.94 | 5 | J | | | | |
| 10 | 27.93 | 5 | K | | | | |

At step 202, a New Sell Order of 27.95×60 is received from trading account N. At step 204, trading module 50 applies trading management rules 68 to determine, based on the offer price of the New Sell Order (27.95) and the bid prices of the buy orders currently in buy order stack, that a subset of the buy orders currently in the buy order stack qualify to match with the New Sell Order. Here, trading module 50 determines that Buy Orders 1-8 qualify (price>27.95) to match with the New Sell Order (price=27.95). Thus, Buy Orders 1-8 comprise the subset of buy orders qualified to trade with the New Sell Order.

In an alternative embodiment, trading module 50 determines the subset of qualified buy orders 40 as including a number of buy orders 40 (starting from the top and progressing down the buy order stack 80) sufficient to cover the size of the new sell order 42, but including each of the buy orders 40 (if any) at the same price as the last buy order 40 necessary to cover the size of the new sell order 42. Thus, supposing that a New Sell Order of 27.95×40 (rather than 27.95×60) was received in the present example, the subset of qualified buy orders 40 would include Buy Orders 1-5 (total size=40) sufficient to cover the size of the New Sell Order (size=40), but also including Buy Order 6 having the same bid price (27.96) as the last buy order (Buy Order 5) necessary to cover the size of the New Sell Order. In this manner, trading module may ensure that all buy orders 40 currently in buy order stack 80 that may potentially be matched with the New Sell Order may be included in the subset of buy orders 40 that are searched for Related Buy Orders at step 206 (discussed below).

The remaining discussion of Example 2 returns to the assumption that the New Sell Order is a sell order of 27.95×60.

At step 206, at this point (the point of trade), trading module 50 applies in-house matching rules to determine whether any of the subset of qualified buy orders, namely Buy Orders 1-8, are related to the New Sell Order by determining whether any of the trading accounts corresponding with Buy Orders 1-8 (Accounts A-H) are related to the trading account 12 associated with the New Sell Order (Account N).

If it is determined at step 206 that none of the Buy Orders 1-8 are related to the New Sell Order, at steps 208-216, trading module 50 applies the regular trading rules to match the New Sell Order with one or more of Buy Orders 1-8, as follows. First, at step 208, trading module 50 matches the New Sell Order with the buy orders at the highest bid price (29.97) in the buy order stack 80, namely Buy Orders 1-4, in time priority order. Thus, trading module 50 will create a first match between the New Sell Order and Buy Order 1 (trade size=5), then a second match between the New Sell Order and Buy Order 2 (trade size=5), then a third match between the New Sell Order and Buy Order 3 (trade size=10), and then a fourth match between the New Sell Order and Buy Order 4 (trade size=15). Each of the first-fourth matches are matched for trading at the price of 29.97.

The first-fourth matches between the New Sell Order and Buy Orders 1-4 account for 35 units the full size (60 units) of the New Sell Order. Thus, 25 units of the New Sell Order remain to be matched, and several of the remaining buy orders 40 in buy order stack 80 (namely, Buy Orders 5-8) have a price qualified to match with that of the New Sell Order. Thus, the method progresses to step 212 (rather than step 210), and trading module 50 offers the remaining 25 units of the New Sell Order to the market at the highest bid price in the buy order stack, namely 29.97, for a determined period of time. A conditional hold may be placed on Buy Orders 5-7 or 5-8, depending on the embodiment. For example, in one embodiment, a conditional hold is placed on qualified buy orders 40 going down the buy order stack 80 in order until the size of the remaining portion of the New Sell Order has been met. In such embodiment, a conditional hold is placed on Buy Orders 5-7, since Buy Orders 5-7 have a total size of 25. In another embodiment, a conditional hold is placed on qualified buy orders 40 going down the buy order stack 80 in order until the size of the remaining portion of the New Sell Order has been met, and also including any buy orders 40 having the same price as the last buy order 40 required to cover the size of the remaining portion of the New Sell Order. In such embodiment, a conditional hold is placed on Buy Orders 5-8, since Buy Orders 5-7 have a total size of 25, sufficient to cover the size of the remaining portion of the New Sell Order (25), but also including Buy Order 8, since Buy Order 8 has the same bid price (27.95) as the last buy order required to cover the 25 remaining units of the New Sell Order, namely Buy Order 7 (27.95). In another embodiment, no conditional holds are implemented.

Assuming trading module 50 places a conditional hold on Buy Orders 5-7, the conditional hold may prevent Buy Orders 5-7 from being cancelled until either (a) the determined period of time for offering the remaining portion of the New Sell Order to the market expires, or (b) one or more buy orders 40 are received, during the determined period of time, to purchase the remaining portion of the New Sell Order being offered to the market at the highest bid price.

If one or more buy orders 40 to purchase the remaining portion of the New Sell Order at the highest bid price (29.97) are received during the determined period of time, the remaining portion of the New Sell Order may be purchased at the highest bid price and the conditional holds on Buy Orders 5-7 are released, at step 214.

Alternatively, if the determined period of time for offering the remaining portion of the New Sell Order at the-highest bid price (29.97) expires before being purchased at that price, the remaining portion of the New Sell Order is matched with the one or more conditionally-held Buy Orders 5-7 in price/time priority order, at step 216. Thus, according to price/time priority rules, trading module 50 will create a fifth match between the New Sell Order and Buy Order 5 (trade size=5), then a sixth match between the New Sell Order and Buy Order 6 (trade size=10), then finally a seventh match between the New Sell Order and Buy Order 7 (trade size=10). Each of the fifth-seventh matches are matched at the price of the respective Buy Order 5-7.

Thus, in summary, if it is determined at step 206 that none of the Buy Orders 1-8 are related to the New Sell Order, trading module 50 will perform the following steps, in order:
1. Match New Sell Order with Buy Order 1 (trade size=5, price=29.97).
2. Match New Sell Order with Buy Order 2 (trade size=5, price=29.97).
3. Match New Sell Order with Buy Order 3 (trade size=10, price=29.97).
4. Match New Sell Order with Buy Order 4 (trade size=15, price=29.97).
5. Offer remaining 25 units of New Sell Order to market at 29.97 for determined offer time period. Place conditional hold on Buy Orders 5-7.
6A. If new buy orders to purchase remaining 25 units of New Sell Order are received during the offer time period, match the new buy orders with the remaining 25 units of New Sell Order, and release the conditional holds on Buy Orders 5-7.
6B. If no buy orders to purchase remaining 25 units of New Sell Order are received during the offer time period:
   a. Match New Sell Order with Buy Order 5 (trade size=5, price=29.96).
   b. Match New Sell Order with Buy Order 6 (trade size=10, price=29.96).
   c. Match New Sell Order with Buy Order 7 (trade size=10, price=29.95).

Alternatively, if it is determined at step 206 that one or more of the Buy Orders 1-8 are related to the New Sell Order, at steps 219-226, trading module 50 applies the “in house matching” rules along with the “trading through the stack” trading rules to match the New Sell Order with one or more of the Buy Orders 1-8. Any of Buy Orders 1-8 that are determined to be related to the New Sell Order may be referred to as Related Buy Orders. Assume for the this example that trading module 50 determines Buy Orders 3 and 6 to be Related Buy Orders (i.e., trading module 50 determines that Accounts C and F associated with Buy Orders 3 and 6 are related to Account N associated with the New Sell Order).

First, at step 218, trading module 50 matches the New Sell Order with one or more buy orders 40 at the highest bid price in the buy order stack 80 for one or more first trades. In determining such match(es), trading module 50 first matches the New Sell Order with any Related Buy Order having the highest bid price (29.97) in the buy order stack 80, in price/time priority order. Thus, trading module 50 creates a first match between the New Sell Order and Related Buy Order 3 (trade size=10), which trade is an in-house trade and may thus qualify for the benefits of in-house trading discussed herein, such as reduced or eliminated clearing fees, for example.

Trading module 50 then matches the remaining portion of the New Sell Order with the remaining (unrelated) Buy Orders having the highest bid price (29.97) in the buy order stack 80, in time priority order, beginning at the top of the buy order stack 80. Thus, trading module 50 creates a second match between the New Sell Order and Buy Order 1 (trade size=5), then a third match between the New Sell Order and Buy Order 2 (trade size=5), then a fourth match between the New Sell Order and Buy Order 4 (trade size=15). Each of the second-fourth matches are matched for trading at the price of 29.97.

The first-fourth matches between the New Sell Order and Buy Orders 3, 1, 2 and 4 (in that order) account for 35 units the full size (60 units) of the New Sell Order. Thus, 25 units of the New Sell Order remain to be matched, and several of the remaining buy orders 40 in buy order stack 80 (namely, Buy Orders 5-8) have a price qualified to match with that of the New Sell Order. Thus, the method progresses to step 222 (rather than step 220), and trading module 50 offers the remaining 25 units of the New Sell Order to the market at the highest bid price in the buy order stack including the buy orders matched with the new sell order at step 218, namely 29.97, for a determined period of time.

In some embodiments, a conditional hold may be placed on Buy Orders 5-7 or 5-8, depending on the embodiment, as discussed above regarding step 208. Assuming trading module 50 places a conditional hold on Buy Orders 5-7, the conditional hold prevents Buy Orders 5-7 from being cancelled until either (a) the determined period of time for offering the remaining portion of the New Sell Order to the market expires, or (b) one or more buy orders 40 are received, during the determined period of time, to purchase the remaining portion of the New Sell Order being offered to the market at the highest bid price.

If one or more buy orders 40 to purchase the remaining portion of the New Sell Order at the highest bid price (29.97) are received during the determined period of time, the remaining portion of the New Sell Order may be purchased at the highest bid price and the conditional holds on Buy Orders 5-7 are released, at step 224.

Alternatively, if the determined period of time for offering the remaining portion of the New Sell Order at the highest bid price (29.97) expires before being purchased at that price, the remaining portion of the New Sell Order is matched with the one or more conditionally-held Buy Orders 5-7 in price/time priority order and according to the in-house matching rules, at step 216. Thus, trading module 50 first creates a fifth match between the New Sell Order and Related Buy Order 6 (trade size=5, trade price=27.96), then a sixth match between the New Sell Order and (unrelated) Buy Order 5 (trade size=10, trade price=27.96), then a seventh match between the New Sell Order and (unrelated) Buy Order 7 (trade size=10, trade price=27.96), which fully accounts for the remaining 25 units of the New Sell Order. The trade between the New Sell Order and Related Buy Order 6 is an in-house trade and may thus qualify for the benefits of in-house trading discussed herein, such as reduced or eliminated clearing fees, for example.

Thus, in summary, if it is determined at step 206 that Buy Orders 3 and 6 are related to the New Sell Order, trading module 50 will perform the following steps, in order:
1. Match New Sell Order with Related Buy Order 3 (trade size=10, price=29.97).
2. Match New Sell Order with Buy Order 1 (trade size=5, price=29.97).
3. Match New Sell Order with Buy Order 2 (trade size=5, price=29.97).
4. Match New Sell Order with Buy Order 4 (trade size=15, price=29.97).
5. Offer remaining 25 units of New Sell Order to market at 29.97 for determined offer time period. Place conditional hold on Buy Orders 5-7.
6A. If new buy orders to purchase remaining 25 units of New Sell Order are received during the offer time period, match the new buy orders with the remaining 25 units of New Sell Order, and release the conditional holds on Buy Orders 5-7.
6B. If no buy orders to purchase remaining 25 units of New Sell Order are received during the offer time period:
   a. Match New Sell Order with Related Buy Order 6 (trade size=10, price=29.96).
   b. Match New Sell Order with Buy Order 5 (trade size=5, price=29.96).
   c. Match New Sell Order with Buy Order 7 (trade size=10, price=29.95).
      Applying In-House Matching Rules with “Mini-Auction” Regular Trading Rules.

In some embodiments, trading management rules 68 generally provide for applying in-house matching rules to “mini-auction” regular trading rules. Such “mini-auction” trading rules may include trading rules that provide for an auction between traders to trade with a particular (e.g. newly received) buy or sell order entering the market. One example of such “mini-auction” trading rules is provided by the Boston Options Exchange “PIP” matching algorithms, which are generally described at http://www.bostonoptions.com/index.php.

In general, in embodiments in which an auction is executed between traders wishing to trade with a particular trading order, in-house matching rules may be applied after the completion of the auction period but before trades are matched (i.e., after the final auction entries are received from the various traders participating in the auction) to determine one or more winning entries. In some embodiments, in-house matching rules may be applied after the completion of the auction to determine one or more winning auction entries only from the final auction entries having the same (best) price for the particular trading order. For example, where multiple final auction entries from multiple trading accounts 12 have the same (best) price for trading with a particular trading order from a particular trading account 12, in-house matching rules may be applied to give priority to any of such final auction entries that are related to the particular trading order in determining the winner(s) of the auction. Trading module 50 may determine whether particular auction entries are related to the particular trading order by determining, for example, whether the trading accounts 12 associated with such auction entries are related to the particular trading account 12, such as described above.

Thus, if three final auction entries having the same (best) price are received for a particular sell order 42 from a particular trading account 12 being auctioned, and one of the three final auction entries is received from a trading account 12 that is related to the particular trading account 12, in-house matching rules may be applied to declare the related final auction entry the winner of the auction, and thus first execute (or allow the execution of) a trade between the related auction entry and at least a portion of the particular sell order 42.

In particular embodiments, in-house matching rules may only give a related auction entry (i.e., an auction entry from a trading account 12 related to the trading account 12 associated with the trading order 18 being auctioned) priority over non-related auction entries that have the same price as the related auction entry. In-house matching rules may not elevate the priority of a related auction entry over non-related auction entry that have better prices than the related auction entry. In this manner, the trading entity 20 placing the trading order 18 being auctioned is protected from being financially disadvantaged by being matched and traded with an auction entry having a price less favorable to the particular trader than one or more other, non-related auction entries.

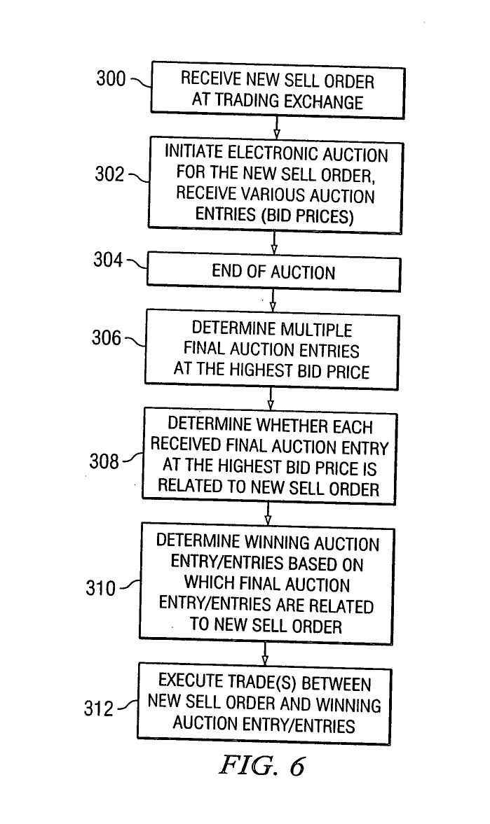

FIG. 6 illustrates an example method of applying such trading management rules 68 in a particular embodiment of the invention. It should be understood that although the following discussion involves a new sell order 42 being received at trading exchange 14 and auctioned to interested buyers, the same or similar principals apply equally to situations in which a new buy order 40 is received at trading exchange 14 and auctioned to interested sellers.

At step 300, a new sell order 42 having an offer price is received at trading exchange 14 from a particular trading account 12. In response, at step 302, trading module 50 initiates and manages an electronic auction to trade with the new sell order 42. During the auction, various auction entries (i.e., bid prices) for trading with the new sell order 42 are electronically received from various trading accounts 12, such as via various trading entities 20 using trader workstations 46. The auction may be blind, semi-blind, or transparent such that each trading entity 20 participating in the auction may or may not have knowledge of the auction entries being submitted by each other trading entity 20. Auction entries may be submitted for the duration of the auction, which duration may or may not be predetermined prior to the auction.

At step 304, the auction ends. The final auction entries (i.e., bid prices) received from each trading entity 20 participating in the auction may be determined at step 306. In this example, trading module 50 determines that multiple final auction entries have the same (highest) bid price. Thus, trading module 50 needs to determine which of such multiple final auction entries is/are winning entries. At step 308, trading module 50 may electronically determine whether each received final auction entry (or particular received final auction entries) is related to the new sell order 42, such as by determining whether the trading account 12 associated with each final auction entry is related to the particular trading account 12 associated with the new sell order 42, for example.

At step 310, trading module 50 applies in-house matching rules to determine which of the multiple final auction entries having the same (highest) bid price is/are winning entries. In particular, in-house matching rules may give priority to any of such multiple final auction entries that are related to the particular sell order 42, as determined at step 308, to determine the winner(s) of the auction. Thus, supposing that at least one of the multiple final auction entries having the same (highest) bid price are related to the new sell order 42, and at least one of the multiple final auction entries are not related to the new sell order 42, trading module 50 may apply in-house matching rules to declare one (or more) of the related final auction entries the winner of the auction. At step 312, trading module 50 may automatically execute (or allow the execution of) a trade between the new sell order 42 and the winning auction entry (or entries) determined at step 310.

Applying In-House Matching Rules with Regular Pro Data Trading Rules.

In some embodiments, trading management rules 68 generally provide for applying in-house matching rules to regular pro rata trading rules. Such pro rata trading rules may divide and trade a new trading order 18 with multiple contra trading orders 18 at a particular price according to any suitable pro rata rules or algorithms. Particular examples of such pro rata trading rules are described in U.S. Pat. No. 6,618,707, issued on Sep. 9, 2003. Another example of pro rata matching rules is used in some futures trading systems where orders at the same price when matched by a contra order are traded in pro rata portions, according to a pre-determined algorithm designed to share trades between multiple orders of the same price and type.

In some embodiments, in-house matching rules may be applied to such pro rata regular trading rules such that when a particular trading order 18 is divided and traded with multiple contra trading orders 18, the pro rata portions of the particular trading order 18 assigned to each of the multiple contra trading orders 18 are determined based at least in part on whether each of such multiple contra trading orders 18 is related to the particular trading order 18. Thus, for example, where regular pro rata trading rules would divide a particular trading order 18 in half to trade with two contra trading orders 18 (such that one half of the particular trading order 18 would trade with each contra trading order 18), in-house matching rules may be applied to the regular pro rata rules to adjust the pro rata portions such that a larger portion (e.g. ⅔) of the particular trading order 18 is allocated to be matched with one of the two contra trading orders 18 that is related to the particular trading order 18, while the remaining smaller portion (e.g. ⅓) of the particular trading order 18 is allocated to be matched with the other of the two contra trading orders 18 that is not related to the particular trading order 18. In some embodiments, the regular pro rata trading rules and in-house matching rules are applied in combination without intentionally implemented delay.

Trading management rules 68 may determined the pro rata portions of a particular trading order 18 assigned to be traded with each of multiple contra trading orders 18 based on any suitable criteria, such as whether each contra trading orders 18 is related to the particular trading order 18 (as discussed above), the size of each contra trading order 18, the time priority of each contra trading orders 18, the type of trading entity 20 associated with each contra trading orders 18, the type of trading account 12 associated with each contra trading orders 18, various statistics regarding the trading account 12 associated with each contra trading orders 18 (such as trading volume, for example), or any other suitable criteria that may distinguish the various contra trading orders 18.

Broadcasting/Not Broadcasting In-House Trades to the Market

In any of the trading and order routing systems described above, a trading state may be used to transparently broadcast to trading entities 20 trade matches as they occur. In others, an increment to the size traded at a particular price level may be used to indicate trade matches, in either a real time or a delayed fashion.

In some embodiments, some or all in house trade matches (for example, in house trade matches that would not have occurred without the relevant in house matching rules) are not broadcast to market participants in general. Thus, trading entities 20 not associated with such in house trade matches may not be notified of such in house trade matches. For example, a trading order 18 that is in house matched with a contra trading order 18 may be simply removed from the trading display, thus giving the appearance that the trading order 18 was simply withdrawn from the exchange.

In other embodiments, some or all in house trade matches (for example, in house trade matches that would not have occurred without the relevant in house matching rules) are broadcast to market participants in general such that trading entities 20 not associated with such in house trade matches are notified of such in house trade matches. For example, in some embodiments in which running or accumulating counters indicating total sizes traded at various price levels are maintained and broadcast to the market in general, such counters may be updated to account for both in-house matches and non-in-house matches. In other embodiments, separate counters for in-house matches and non-in-house matches at various price levels may be maintained and broadcast to the market. Such counters may be updated in real time or in a delayed fashion.

Electronic Order Routing System

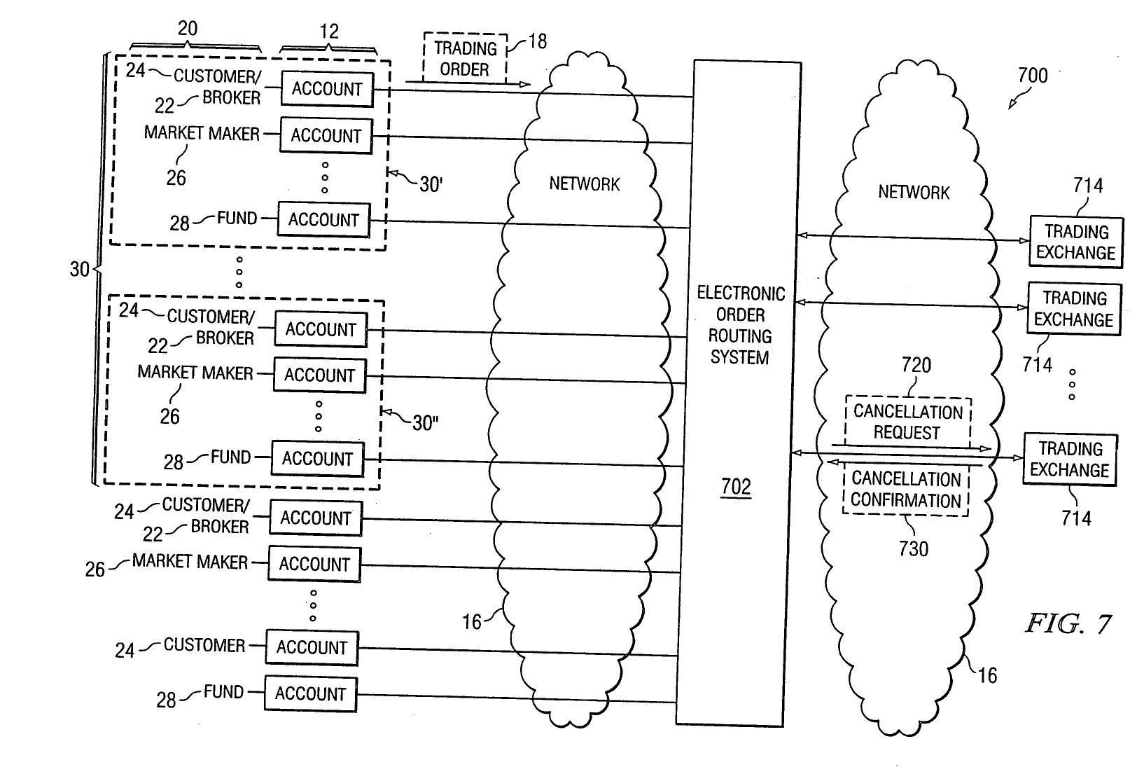

FIG. 7 illustrates an example trading system 700 including an electronic order routing system, or aggregator of markets, 702 operable to route trading orders 18 to multiple electronic trading exchanges 714 and manage trading, including in-house matching of related trading orders 18, among the multiple trading exchanges 714 in accordance with one embodiment of the invention.

Trading system 700 includes a-plurality of trading accounts 12 having access to multiple trading exchanges 714 via an electronic order routing system 702. Each trading exchange 714 may be similar to trading exchange 14 discussed above. As discussed above with reference to FIGS. 1-2, various trading entities 20 may use trading accounts 12 to place trading orders 18 on one or more trading exchanges 714, which trading exchanges 714 may match trading orders 18 according to relevant matching rules.

In general, electronic order routing system 702 receives trading orders 18 from various trading accounts 12 and forwards each received trading order 18 to one of the multiple trading exchanges 714 using algorithms based on one or more various factors, such as the current real-time (or near real-time) pricing at each of the various trading exchanges, for example. For example, electronic order routing system 702 may monitor prices at each trading exchange 714 and route each new trading order 18 to the trading exchange 714 having the best price for trading with that new trading order 18. Electronic order routing system 702 may employ known routing algorithms and techniques, including for example, algorithms for breaking up and distributing large orders to one or more electronic communications networks (ECNs) or exchange marketplaces, such as to avoid “spooking” the market with the large orders.

When electronic order routing system 702 receives from a particular trading account 12 a new trading order 18 that has a price that would trade with one or more contra trading orders 18 previously routed by electronic order routing system 702 to one or more trading exchanges 714, electronic order routing system 702 may determine whether any of such contra trading orders 18 are related to the new trading order 18 by determining whether any of the contra trading orders 18 were received from trading accounts 12 that have a particular relationship with the particular trading account 12, such as discussed above with reference to any of FIGS. 1-6.

If electronic order routing system 702 determines that any of such contra trading orders 18 are related to the new trading order 18, electronic order routing system 702 may send a cancellation request or command 720 to the particular trading exchange(s) 714 to which one or more of the related contra trading orders 18 were previously routed to cancel at least a portion of such one or more related contra trading orders 18 from such particular trading exchange(s) 714. If electronic order routing system 702 receives a confirmation 730 that any portion (or all) of the related contra trading orders 18 were indeed cancelled in response to the request or command 720 sent by electronic order routing system 702, electronic order routing system 702 may then execute trade(s) between the new trading order 18 and the portion (or all) of the related contra trading order(s) 18 cancelled from the trading exchange 714, either facilitating clearance and settlement itself (such as in the case of an OTC bond trade, for instance), or registering the trade on one or more of the trading exchanges 714 for such (such as in the case of a futures trade, for instance). If any portion of the new trading order 18 remains unmatched by the related contra trading order(s) 18 cancelled, electronic order routing system 702 may forward the remaining portion of the new trading order 18 to one of the trading exchanges 714 based on one or more various factors, such as discussed above.

In some embodiments, electronic order routing system 702 may ensure (or attempt to ensure) that a new trading order 18 will be not be matched with a related trading order 18 when there is/are non-related trading order(s) 18 at better prices than the related trading order 18 available on one or more of trading exchanges 714 to trade with the new trading order 18. Thus, in some embodiments, electronic order routing system 702 may only send cancellation requests or commands 72 to trading exchange 714 to cancel related trading orders 18 at the best price available (i.e., the price most favorable to the new trading order 18) on any of the trading exchanges 714. In this manner, the trading entity 20 placing the new trading order 18 is protected from being financially disadvantaged by being matched and traded with related trading order(s) 18 instead of non-related trading order(s) 18 at a better price.

It should be understood that various components of system 700 may employ any of the various rules and techniques for matching trading orders 18 discussed herein.

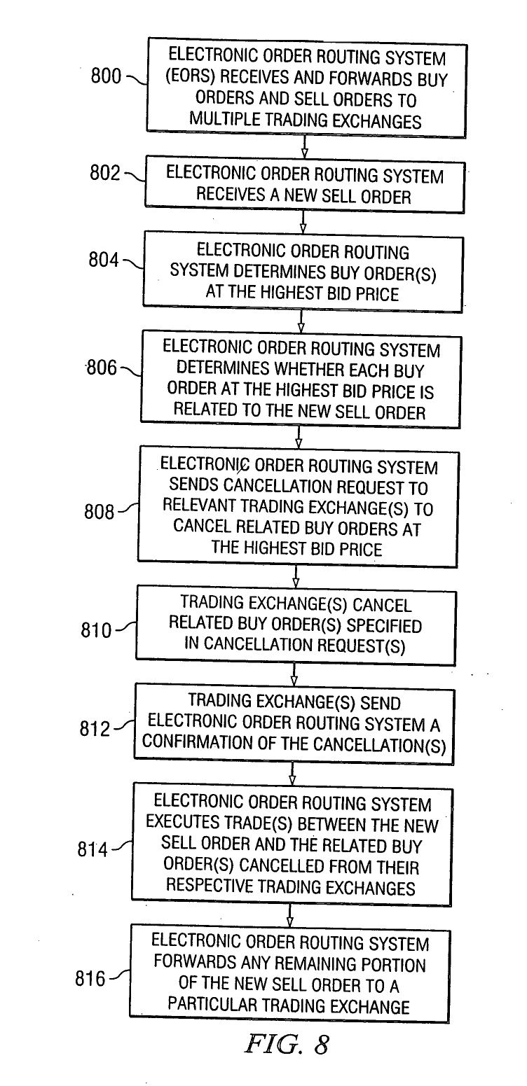

FIG. 8 illustrates an example method of the trading system 700 of FIG. 7 managing the matching and trading of trading orders in a particular embodiment of the invention. It should be understood that although the following discussion involves a new sell order 42 being received by an electronic order routing system 702 and traded with related and/or non-related buy orders 40, the same or similar principals apply equally to situations in which a new buy order 40 is received by an electronic order routing system 702 and traded with related and/or non-related buy orders 40.

At step 800, buy orders 40 and sell orders 42 are received by electronic order routing system 702 from various trading entities 20 using various trading accounts 12. Electronic order routing system 702 routes such received buy orders 40 and sell orders 42 to various trading exchanges 714 using algorithms based on one or more various factors, such as the current real-time (or near real-time) pricing at each of the various trading exchanges 714, for example. Each trading exchange 714 may manage the matching and execution of trades between the various buy orders 40 and sell orders 42 routed to that trading exchange 714 by electronic order routing system 702 or otherwise received by that trading exchange 714.

At step 802, electronic order routing system 702 receives from a particular trading account 12 a new sell order 42 that has a price that would trade with one or more buy orders 40 previously routed to one or more trading exchanges 714 at step 800. At step 804, in response to receiving the new sell order 42, electronic order routing system 702 may communicate with the multiple trading exchanges 714 to determine one or more buy orders 40 on such trading exchanges 714 at the best (i.e., highest) bid price available for trading with the new sell order 42. At step 806, electronic order routing system 702 may electronically determine whether each of such buy order(s) 40 at the best bid price is related to the new sell order 42, such as by determining whether the trading account 12 associated with each buy order 40 is related to the particular trading account 12 associated with the new sell order 42, such as discussed above with reference to any of FIGS. 1-6, for example.

If electronic order routing system 702 determines that any of such buy orders 40 are related to the new sell order 42, at step 808, electronic order routing system 702 may send to the particular trading exchange(s) 714 to which each related buy order 40 was previously routed a cancellation request or command 720 to cancel at least a portion (depending on the relative size of the new sell order 42 and the related buy order(s) 40) of that related buy order 42 from the relevant trading exchange 714. At step 810, each trading exchange 714 that receives such a cancellation request or command 720 from electronic order routing system 702 may cancel the specified portion (or all) of the relevant related buy order(s) 40 from that trading exchange 714 (assuming such related buy order(s) 40 have not been traded or otherwise removed from that trading exchange 714 by that time).

At step 812, each trading exchange 714 that cancels the specified portion (or all) of the relevant related buy order(s) 40 from that trading exchange 714 may communicate to electronic order routing system 702 a confirmation 730 of the cancellation. If electronic order routing system 702 receives such confirmation(s) 730 that the portions (or all) of the related buy orders 40 were indeed cancelled, at step 814, electronic order routing system 702 may then execute trade(s) between the new sell order 42 and the portion (or all) of the related buy order(s) 42 that were cancelled from their respective trading exchanges 714. Electronic order routing system 702 may (a) facilitate clearance and settlement of such trade(s) itself (such as in the case of an OTC bond trade, for instance), or (b) register the trade on one or more of the trading exchanges 714 for such clearance and settlement (such as in the case of a futures trade, for instance). If any portion of the new sell order 42 remains unmatched by the related buy order(s) 42 at step 814, electronic order routing system 702 may forward the remaining portion of the new sell order 42 to one of the trading exchanges 714 at step 816 based on one or more various factors, such as discussed above.

Although an embodiment of the invention and its advantages are described in detail, a person skilled in the art could make various alterations, additions, and omissions without departing from the spirit and scope of the present invention as defined by the appended claims.

1. A method for managing electronic trading, comprising:
in an electronic market having trade matching rules, receiving a plurality of first orders, each associated with an account, and receiving a contra order associated with a particular account;
for each of one or more first orders, electronically determining whether that first order is a related first order by determining whether the account associated with that first order has a particular relationship with the particular account associated with the contra order; and
without intentionally introduced delay, electronically determining one or more particular first orders, including one or more related first orders, to trade with the contra order based at least on the trade matching rules and the determination of related first orders; and
automatically executing one or more trades between the one or more particular first orders and the contra order.

2. The method of claim 1, wherein:
each first order and the contra order have a price;
the price of the contra order matches or crosses the price of a subset of one or more first orders in the order list; and
electronically determining whether each of one or more first orders is a related first order comprises electronically determining whether each of the subset of first orders is a related first order.

3. The method of claim 1, comprising automatically displaying to the market an indication of the one or more trades between the one or more related first orders and the contra order trade such that market participants not associated with the trade are notified of the one or more trades.

4. The method of claim 1, wherein determining one or more particular first orders to trade with the contra order based at least on the trade matching rules and the determination of related first orders comprises:
determining at least one first trade to execute between the contra order and at least one related first order;
automatically executing the at least one first trade;
if, after accounting for the at least one first trade, any portion of the contra order remains available to be traded, determining, based on the trade matching rules, at least one second trade to execute between the contra order and at least one non-related first order; and
automatically executing the at least one second trade.

5. The method of claim 4, comprising:
for at least one of the one or more related first orders, not displaying to the market an indication of the particular first trade between that related first order and the contra order trade such that market participants not associated with the trade are not notified of the particular first trade;
automatically displaying to the market an indication of each second trade between a non-related first order and the contra order trade such that market participants not associated with the trade are notified of each second trades.

6. The method of claim 5, comprising:
each first order having a size;
displaying to market participants having access to the electronic market an accumulating count of the size of first orders traded at one or more prices;
wherein not displaying to the market an indication of the particular first trade such that market participants not associated with the trade are not notified of the particular first trade comprises not incrementing the displayed accumulating count to account for the particular first trade; and
wherein automatically displaying to the market an indication of each second trade such that market participants not associated with the trade are notified of each second trade comprises incrementing the displayed accumulating count to account for each second trade.

7. The method of claim 1, wherein:
the trade matching rules of the electronic market include:
price/time priority matching rules operable to automatically assign a priority to each first order based on a price/time priority algorithm; and
in-house matching rules operable to automatically adjust the priority of one or more first orders based on the determination of related first orders; and
determining one or more particular first orders to trade with the contra order comprises determining one or more particular first orders to trade with the contra order based at least on the priority of first orders defined by both the price/time priority matching rules and the in-house matching rules.

8. The method of claim 7, wherein:
each first order has a price; and
the in-house matching rules are operable to automatically enhance the priority of related first orders with respect to non-related first orders having the same price.

9. The method of claim 7, wherein:
each first order has a price; and
the in-house matching rules are operable to automatically enhance the priority of related first orders only with respect to non-related first orders having the same price.

10. The method of claim 1, wherein:
the trade matching rules of the electronic market include:
pro rata matching rules operable to automatically assign a pro rata portion of each of multiple first orders to trade with another order; and
in-house matching rules operable to automatically adjust the pro rata portion of one or more first orders determined to trade with another order based on the determination of related first orders; and
determining one or more particular first orders to trade with the contra order comprises increasing the pro rata portions of one or more related first orders to trade with the contra order with respect to one or more non-related first orders to trade with the contra order based at least on both the pro rata matching rules and the in-house matching rules.

11. The method of claim 10, wherein:
each first order has a price; and
the in-house matching rules are operable to automatically increase the pro rata portion of related first orders with respect to non-related first orders having the same price.

12. The method of claim 10, wherein:
each first order has a price; and
the in-house matching rules are operable to automatically increase the pro rata portion of related first orders only with respect to non-related first orders having the same price.

13. The method of claim 1, wherein:
the trade matching rules of the electronic market include:
auction matching rules operable to manage an auction to determine multiple first orders qualified to win an auction to trade with another order, each first order comprising a final auction entry in the auction; and
in-house matching rules operable to automatically determine one or more auction winning first orders from the multiple qualified first orders based on the determination of related first orders; and
determining one or more particular first orders to trade with the contra order comprises determining one or more auction winning first orders based at least on the auction matching rules and the in-house matching rules.

14. The method of claim 13, wherein:
each final auction entry in the auction has a price; and
each of the multiple first orders qualified to win an auction has the same price.

15. The method of claim 1, wherein a particular account associated with one or more particular received first orders is a proxy for multiple subsidiary accounts.

16. The method of claim 1, wherein determining one or more particular first orders to trade with the contra order based at least on the trade matching rules and the determination of related first orders comprises:
if one or more first orders at a particular price are determined to be related first orders, automatically determining at least one trade to be executed between the contra order and at least one of the related first orders at the particular price; and
if none of the first orders at the particular price are determined to be related first orders, automatically determining at least one trade to be executed between the contra order and at least one of the non-related first orders at the particular price.

17. The method of claim 1, further comprising:
placing the plurality of received first orders into a buy order list maintained by the electronic market, each buy order having a bid price; and
wherein the contra order comprises a sell order having an offer price lower than or matching the bid price of one or more buy orders in the buy order list.

18. The method of claim 1, further comprising:
placing the plurality of received first orders into a sell order list maintained by the electronic market, each sell order having an offer price; and
wherein the contra order comprises a buy order having a bid price higher than or matching the offer price of one or more sell orders in the sell order list.

19. The method of claim 1, comprising:
placing the received first orders in a sequence in a first order list;
displaying to market participants having access to the electronic market the sequence of the first orders in the first order list;
wherein electronically determining whether each of one or more first orders is a related first order comprises:
electronically determining that a first particular order at the front of the first order list is not a related first order; and
electronically determining that a second particular order not at the front of the first order list is a related first order; and
wherein determining one or more particular first orders to trade with the contra order based at least on the trade matching rules and the determination of related first orders comprises determining the second particular order, but not the first particular order, to trade with the contra order; and
automatically executing a trade between the contra order and the second particular order.

20. The method of claim 19, wherein the first particular order and the second particular order have the same price.

21. The method of claim 19, further comprising not displaying to the market an indication of the trade between the contra order and the second particular order such that market participants not associated with the trade are not notified of the trade.

22. The method of claim 1, wherein electronically determining one or more particular first orders to trade with the contra order without intentionally introduced delay comprises determining one or more particular first orders to trade with the contra order without waiting for input that may influence the determination of the one or more particular first orders to trade with the contra order.

23. The method of claim 1, wherein electronically determining whether each of one or more first orders is related to the contra order comprises determining whether the account associated with that first order and the particular account associated with the contra order are associated with the same company.

24. The method of claim 1, wherein electronically determining whether each of one or more first orders is related to the contra order comprises determining whether the account associated with that first order and the particular account associated with the contra order are associated with the same legal entity.

25. The method of claim 1, wherein electronically determining whether each of one or more first orders is related to the contra order comprises determining whether the account associated with that first order and the particular account associated with the contra order are associated with the same holding company.

26. The method of claim 1, wherein electronically determining whether each of one or more first orders is related to the contra order comprises determining whether the account associated with that first order and the particular account associated with the contra order are associated with entities having a predetermined relationship regarding trading in the electronic market.

27. The method of claim 1, wherein electronically determining whether each of one or more first orders is related to the contra order comprises determining whether the account associated with that first order and the particular account associated with the contra order are on a predetermined list of related trading entities.

28. A method for managing electronic trading, comprising:
in an electronic market, receiving a plurality of orders including buy orders and sell orders, each order having a price;
electronically determining that the price of a first one of the plurality of orders matches or crosses the price of a second one of the plurality of orders and a third one of the plurality of orders, the first order being received from a first trading entity, the second order being received from a second trading entity, and the third order being received from a third trading entity;
electronically determining whether the second trading entity has a particular relationship with the first trading entity; and
if the second trading entity has the particular relationship with the first trading entity, without intentionally introduced delay, automatically initiating a trade between the first order and the second order; and
if the second trading entity does not have the particular relationship with the first trading entity, without intentionally introduced delay, automatically initiating a trade between the first order and the third order.

29. The method of claim 28, further comprising placing each received order into an associated order stack, including placing the second order and the third order in a particular order stack such that the third order is positioned ahead of the second order in the particular order stack.

30. The method of claim 29, wherein the third order is positioned ahead of the second order according to time priority in the particular order stack.

31. The method of claim 28, wherein:
automatically initiating a trade between the first order and the second order without intentionally introduced delay comprises automatically initiating a trade between the first order and the second order without waiting for input that may influence the automatic initiation of the trade between the first order and the second order; and
automatically initiating a trade between the first order and the third order without intentionally introduced delay comprises automatically initiating a trade between the first order and the third order without waiting for input that may influence the automatic initiation of the trade between the first order and the third order.

32. The method of claim 28, wherein electronically determining whether the second trading entity has the particular relationship with the first trading entity comprises determining whether the second trading entity and the first trading entity are associated with the same company.

33. The method of claim 28, wherein electronically determining whether the second trading entity has the particular relationship with the first trading entity comprises determining whether the second trading entity and the first trading entity are associated with the same legal entity.

34. The method of claim 28, wherein electronically determining whether the second trading entity has the particular relationship with the first trading entity comprises determining whether the second trading entity and the first trading entity are associated with entities associated with the same holding company.

35. The method of claim 28, wherein electronically determining whether the second trading entity has the particular relationship with the first trading entity comprises determining whether the second trading entity and the first trading entity are associated with entities having a predetermined relationship regarding trading in the electronic market.

36. The method of claim 28, wherein electronically determining whether the second trading entity has the particular relationship with the first trading entity comprises determining whether the second trading entity and the first trading entity are on a predetermined list of related trading entities.

37. The method of claim 28, wherein:
the third order is positioned ahead of the second order in a order stack;
the first order has a first order size and the second order has a second order size; and
the method comprises, if the second trading entity has the particular relationship with the first trading entity:
if the first order size is less than or equal to the second order size, automatically initiating a trade of the first order size between the first order and the second order;
if the first order size is greater than the second order size, automatically initiating a first trade between the second order and a first portion of the first order equal to the second order size, and automatically initiating a second trade between the third order and a remaining portion of the first order.

38. The method of claim 28, wherein:
the third order is positioned ahead of the second order in a order stack;
the second order is positioned ahead of a fourth one of the plurality of orders, the fourth order being received from a fourth trading entity;
the first order has a first order size, the second order has a second order size, and the fourth order has a fourth order size; and
the method comprises:
electronically determining that the price of the first order matches or crosses the price of a fourth order;
electronically determining whether the fourth trading entity has a particular relationship with the first trading entity; and
if both the second trading entity and the fourth trading entity have the particular relationship with the first trading entity:
if the first order size is less than or equal to the second order size, automatically initiating a trade of the first order size between the first order and the second order;
if the first order size is greater than the second order size, automatically initiating a first trade between the second order and a first portion of the first order equal to the second order size, automatically initiating a second trade between the fourth order and a remaining portion of the first order; and
if the first order size is greater than the sum of the second order size and fourth order size, automatically initiating a first trade between the second order and a first portion of the first order equal to the second order size, automatically initiating a second trade between the fourth order and a second portion of the first order equal to the fourth order size, and automatically initiating a third trade between the third order and a remaining portion of the first order.

39. The method of claim 28, wherein:
the third order is positioned ahead of the second order in a order stack;
the second order has a second order size and the third order has a third order size; and
the method comprises:
if the second trading entity does not have the particular relationship with the first trading entity, automatically determining without intentionally introduced delay, based at least on the second order size and the third order size, a first pro rata portion of the first order to be traded with the second order and a second pro rata portion of the first order to be traded with the third order, and automatically initiating a first trade between the second order and the first pro rata portion of the first order and a second trade between the third order and the second pro rata portion of the first order; and
if the second trading entity has the particular relationship with the first trading entity, automatically determining without intentionally introduced delay, based at least on the second order size and the third order size, an increased pro rata portion of the first order to be traded with the second order and a decreased pro rata portion of the first order to be traded with the third order, and automatically initiating a first trade between the second order and the increased pro rata portion of the first order and a second trade between the third order and the decreased pro rata portion of the first order, wherein the increased pro rata portion of the first order is greater than the first pro rata portion of the first order, and the decreased pro rata portion of the first order is smaller than the second pro rata portion of the first order.

40. A method for managing electronic trading, comprising:
in an electronic market, receiving a first order;
during an auction for trading with the first order, receiving at least a first final auction entry and a second final auction entry;
electronically determining that the first final auction entry is related to the first order and the second final auction entry is not related to the first order;
based at least on the relative prices of the at least first and second final auction entries and the determination that first final auction entry is related to the first order, determining the first final auction entry to be executed first; and
executing a trade between the first order and the first final auction entry.

41. The method of claim 40, wherein determining the first final auction entry to be executed first comprises determining the first final auction entry to be executed first only if the price of the first auction entry is at the best auction price available for the first order.

42. The method of claim 40, wherein:
the first order is received from a first account;
the first final auction entry is received from a second account;
the second final auction entry is received from a third account; and
determining that the first final auction entry is related to the first order and the second final auction entry is not related to the first order comprises determining that the second account is related to the first account and the third account is not related to the first account.

43. The method of claim 40, wherein:
determining the first final auction entry to be executed first comprises determining the first final auction entry to be executed first and the second final auction entry to be executed second; and
the method further comprises, after executing a trade between the first order and the first final auction entry, executing a trade between the first order and the second final auction entry.

44. The method of claim 40, wherein determining the first final auction entry to be executed first comprises determining only the first final auction entry to be executed for the first order.

45. The method of claim 40, wherein electronically determining that the second account is related to the first account comprises determining that the second account and the first account are associated with the same company.

46. The method of claim 40, wherein electronically determining that the second account is related to the first account comprises determining that the second account and the first account are associated with the same legal entity.

47. The method of claim 40, wherein electronically determining that the second account is related to the first account comprises determining that the second account and the first account are associated with the same holding company.

48. The method of claim 40, wherein electronically determining that the second account is related to the first account comprises determining that the second account and the first account have a predetermined relationship in the electronic market.

49. The method of claim 40, wherein electronically determining that the second account is related to the first account comprises determining that the second account is on a predetermined list of entities related to the first account.

50. A method for managing electronic trading, comprising:
electronically receiving a plurality of orders, each order associated with an account and having a price;
electronically routing each of the received orders to one of multiple electronic markets;
electronically receiving a contra order associated with a particular account;
electronically determining, for one or more of the routed orders, whether that routed order is related to the contra order by determining whether the account associated with that routed order has a relationship with the particular account associated with the contra order;
if at least one routed order having an appropriate price is determined to be related to the contra order, communicating a message to the electronic market to which a particular related first order was routed to cancel at least a portion of the particular related order;
causing a trade between the contra order and the cancelled portion of the related order; and
if no routed order having an appropriate price is determined to be related to the contra order, routing the contra order to one of the multiple electronic markets.

51. The method of claim 50, wherein routing each of the received orders to one of the multiple electronic markets comprises routing based at least on current price information associated with one or more of the multiple electronic markets.

52. The method of claim 50, wherein routing each of the received orders to one of the multiple electronic markets comprises routing at least one order to a first electronic market and routing at least one order to a second electronic market.

53. The method of claim 50, wherein:
electronically routing each of the received orders to one of the multiple electronic markets comprises electronically routing each of at least one buy order to one of the multiple electronic markets, each buy order having a bid price; and
electronically receiving a contra order comprises electronically receiving a sell order having an offer price of lower or equal value than the bid price of one or more of the routed buy orders.

54. The method of claim 50, wherein:
electronically routing each of the received orders to one of the multiple electronic markets comprises electronically routing each of at least one sell order to one of the multiple electronic markets, each sell order having an offer price; and
electronically receiving a contra order comprises electronically receiving a buy order having a bid price of higher or equal value than the offer price of one or more of the routed sell orders.

55. The method of claim 50, wherein:
electronically determining whether each of one or more routed orders is related to the contra order comprises:
electronically determining that a first order routed to a particular one of the multiple electronic markets and positioned in a order list is not related to the contra order;
electronically determining that a second order routed to the particular electronic market and positioned behind the first order in the order list is related to the contra order; and
the method further comprises:
in response to determining that the second order is related to the contra order, communicating a message to the particular electronic market to cancel at least a portion of the second order; and
causing a trade between the contra order and the second order.

56. The method of claim 55, comprising:
in response to determining that the first order is not related to the contra order, not communicating a message to the particular electronic market to cancel the first order; and
not causing a trade between the contra order and the first order.

57. The method of claim 55, wherein the first order is positioned ahead of the second order in the order list according to time priority.

58. The method of claim 50, wherein electronically determining whether each of one or more routed orders is related to the contra order comprises determining whether the account associated with that order and the particular account associated with the contra order are associated with the same company.

59. The method of claim 50, wherein electronically determining whether each of one or more routed orders is related to the contra order comprises determining whether the account associated with that order and the particular account associated with the contra order are associated with the same legal entity.

60. The method of claim 50, wherein electronically determining whether each of one or more routed orders is related to the contra order comprises determining whether the account associated with that order and the particular account associated with the contra order are associated with the same holding company.

61. The method of claim 50, wherein electronically determining whether each of one or more routed orders is related to the contra order comprises determining whether the account associated with that order and the particular account associated with the contra order are associated with entities having a predetermined relationship regarding trading in the electronic market.

62. The method of claim 50, wherein electronically determining whether each of one or more routed orders is related to the contra order comprises determining whether the account associated with that order and the particular account associated with the contra order are on a predetermined list of related trading entities.
